(19) United States
(12) Patent Application Publication
(10) Pub. No.: US 2021/0162545 A1
(43) Pub. Date: Jun. 3, 2021

(54) LASER JETS AND NOZZLES, AND OPERATIONS AND SYSTEMS, FOR DECOMMISSIONING

(71) Applicant: Foro Energy, Inc., Houston, TX (US)

(72) Inventors: Brian O. Faircloth, Evergreen, CO (US); Devvrath Khatri, Littleton, CO (US); Gerald Patterson, Katy, TX (US); Daniel L. Wolfe, Houston, TX (US); Scott A. Marshall, Houston, TX (US); Daryl L. Grubb, Houston, TX (US); Paul D. Deutch, Houston, TX (US)

(73) Assignee: Foro Energy, Inc., Houston, TX (US)

(21) Appl. No.: 17/262,743

(22) PCT Filed: Jul. 24, 2019
(86) PCT No.: PCT/US2019/043292

§ 371 Date: Jan. 24, 2021

Related U.S. Application Data
(60) Provisional application No. 62/702,812, filed on Jul. 24, 2018.
(60) Provisional application No. 62/702,769, filed on Jul. 24, 2018.

(51) Int. Cl. B23K 26/38; B23K 26/08; B23K 26/14

(52) U.S. Cl. CPC B23K 26/38; B23K 26/1476; B23K 26/14; B23K 26/0869

(57) ABSTRACT

There is provided high power laser systems, high power laser tools, and methods of using these tools and systems for performing laser operations. In embodiments the laser systems and methods utilize high velocity laser fluid jets, including fluid jets formed from conanda laser jet nozzles and flow through window laser jet nozzles. There is provide a system having a revolving beam dump. Thus, there is also provided high power laser systems, high power laser tools, and methods of using these systems and tools for removing structures, objects, and materials located offshore, under bodies of water and under the seafloor.

This application: (i) claims the benefit of priority to and claims under 35 U.S.C. § 119(e)(1) the benefit of the filing date of US provisional application Ser. No. 62/702,769 filed Jul. 24, 2018; and (ii) claims the benefit of priority to and claims under 35 U.S.C. § 119(e)(1) the benefit of the filing date of U.S. provisional application Ser. No. 62/702,812 filed Jul. 24, 2018, the entire disclosure of each of which are incorporated herein by reference.

### BACKGROUND OF THE INVENTION

### Field of the Invention

The present inventions relate to high power laser systems, high power laser tools, and methods of using these systems and tools to perform laser operations, including removal of structures, equipment, apparatus, objects, and tubulars, including oil field repair, decommissioning and abandonment operations.

As used herein, unless specified otherwise “offshore,” “offshore activities” and “offshore drilling activities” and similar such terms are used in their broadest sense and would include drilling and other activities on, or in, any body of water, whether fresh or salt water, whether manmade or naturally occurring, such as for example rivers, lakes, canals, inland seas, oceans, seas, bays and gulfs, such as the Gulf of Mexico. As used herein, unless specified otherwise the term “offshore drilling rig” is to be given its broadest possible meaning and would include fixed platforms, tenders, platforms, barges, dynamically positioned multiservice vessels, lift boats, jack-ups, floating platforms, drill ships, dynamically positioned drill ships, semi-submersibles and dynamically positioned semi-submersibles.

As used herein, unless specified otherwise the terms “seafloor,” “seabed” and similar terms are to be given their broadest possible meaning and would include any surface of the earth, including for example the mud line, that lies under, or is at the bottom of, any body of water, whether fresh or salt water, whether manmade or naturally occurring.

As used herein, unless specified otherwise the terms “well” and “borehole” are to be given their broadest possible meaning and include any hole that is bored or otherwise made into the earth's surface, e.g., the seafloor or seabed, and would further include exploratory, production, abandoned, reentered, reworked, and injection wells.

As used herein the term “tubular” is to be given its broadest possible meaning and includes conductor, drill pipe, casing, riser, coiled tube, composite tube, vacuum insulated tube (“VIT”), production tubing, piles, jacket components, offshore platform components, production liners, pipeline, and any similar structures having at least one channel therein that are, or could be used, in the drilling, production, refining, hydrocarbon, hydroelectric, water processing, chemical and related industries. As used herein the term “joint” is to be given its broadest possible meaning and includes all types of devices, systems, methods, structures and components used to connect tubulars together, such as for example, threaded pipe joints and bolted flanges. For drill pipe joints, the joint section typically has a thicker wall than the rest of the drill pipe. As used herein the thickness of the wall of a tubular is the thickness of the material between the internal diameter of the tubular and the external diameter of the tubular.

As used herein, unless specified otherwise “high power laser energy” means a laser beam having at least about 1 kW (kilowatt) of power, e.g., excluding laser having powers of less than 0.9 kW. As used herein, unless specified otherwise “great distances” means at least about 500 m (meter). As used herein the term “substantial loss of power,” “substantial power loss” and similar such phrases, mean a loss of power of more than about 3.0 dB/km (decibel/kilometer) for a selected wavelength. As used herein the term “substantial power transmission” means at least about 50% transmittance.

Generally, as used herein the terms “proximal”, “proximal end” and similar such terms mean closer to the laser, or the source of the laser beam generation, along the laser beam path. Generally, as used herein the terms and “distal”, “distal end” and similar such terms means further away from the laser, or the source of laser beam generation, along the laser beam path, and typically closer to the target along the laser beam path.

The term “high velocity flow rate,” unless specified otherwise is to be given its broadest possible meaning, and would exclude flow rates having velocities lower than 322 kpm (200 mph), and would include flows having velocities of about 402 kpm (250 mph) and greater, about 500 kpm (311 mph) and greater, about 600 kpm (373 mph) and greater, about 1,207 kph (750 mph) and greater, from about 402 kpm (250 mph) to about 1,207 kph (750 mph) and all values within these ranges, and greater values. It should be noted that in embodiments high velocity flow rates are utilized and preferred, in other embodiments lower velocity flow rates may be used.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

Generally, the term “about” as used herein unless stated otherwise is meant to encompass a variance or range of ±10%, the experimental or instrument error associated with obtaining the stated value, and preferably the larger of these.

This Background of the Invention section is intended to introduce various aspects of the art, which may be associated with embodiments of the present inventions. Thus, the forgoing discussion in this section provides a framework for better understanding the present inventions, and is not to be viewed as an admission of prior art.

### SUMMARY

In the removal, repair, and decommissioning of structures and their components, including offshore structures, it has long been desirable to have the enhanced ability to reliably and safely cut or section these components for removal and to do so in a controlled and predetermined manner. The present invention, among other things, solves this need by providing the articles of manufacture, devices and processes taught herein.

According, there is provided a high velocity laser jet nozzle, having: nozzle body having a proximal and a distal end; the nozzle body having a fluid conduit defining a fluid path, wherein the conduit has a velocity acceleration section located near the distal end of the nozzle; whereby the velocity of a fluid moving along the fluid path is accelerated by the velocity acceleration section; the nozzle body having a laser beam passage, the laser beam passage having a laser beam path; the laser beam path and the fluid path being coincident at a location where the fluid moving along the fluid path has been accelerated; and, whereby the nozzle is configured to provide a laser beam within a fluid jet having a velocity in m/sec that is from 0.005 to 0.016 of the flow rate in SCFM

Further, there is provided these nozzles, systems and methods having one or more of the following features: wherein the nozzle is a conanda laser jet nozzle; wherein the nozzle is a flow through window laser jet nozzle; wherein the laser beam has a laser beam cross section and the fluid jet having the accelerated velocity has an accelerated fluid jet cross section; and, wherein the accelerated fluid jet cross section is greater than the laser beam cross section; wherein the fluid passage is in fluid communication with a source of nitrogen, whereby the fluid jet consists essentially of nitrogen; and, wherein the accelerated fluid jet cross section and the laser beam cross section are diameters.

Yet further, there is provided a method of performing a laser operation including: combining a high power laser beam with a fluid jet, having a high velocity jet component; thereby defining a fluid laser jet; the laser beam having a first cross section; and the high velocity fluid jet component having a second cross section; directing the fluid laser jet to a target having a surface; whereby the laser beam impinges upon the target, thereby forming a cut into the target and forming a waste material within the cut, the cut having third cross section at the surface; wherein at the surface of the target, the first cross section and at the third cross section are larger than the second cross section; whereby waste material is removed from the cut by the high velocity fluid flow.

Moreover, there is provided these nozzles, systems and methods having one or more of the following features: wherein the laser beam has a power of from about 2 kW to about 40 kW; wherein the velocity of the velocity of the high velocity jet component at the surface of the target is not less than 5 m/sec; wherein the flow rate of the fluid jet is not greater than 1600 SCFM; wherein at least 80% of the waste material is removed from the cut and the fluid jet has a flow rate of less than 1,000 SCFM; wherein at least 95% of the waste material is removed from the cut; wherein at least 99% of the waste material is removed from the cut; and, wherein 100% of the waste material is removed from the cut.

Furthermore, there is provided a method of removing a section of a member from an offshore structure including: operably associating a high power laser system with the offshore structure, the high power laser system having a high power laser and a high power laser cutting tool; the high power laser cutting tool having a high velocity laser jet nozzle, wherein the nozzle is selected from the group consisting of conanda laser jet nozzles and flow through window laser jet nozzles; the high power laser cutting tool defining a laser beam delivery path for delivery of a high power laser beam along the beam path; positioning the laser cutting tool adjacent a member of the offshore structure, whereby the laser beam path extends from the cutting tool to the member; propagating a high power laser beam along the beam path and moving the beam path and laser beam thereby cutting the member, whereby a section of the member is formed in a predetermined manner; and, removing the section from the structure.

In addition, there is provided these nozzles, systems and methods having one or more of the following features: wherein the member is located below a surface of a body of water; wherein the member is a tubular and the cut is an inside-to-outside cut; wherein the member is a tubular and the cut is an outside-to-inside cut; wherein at least a portion of the member is located above the surface of a body of water; wherein at least a portion of the member is located below a sea floor; wherein at least a portion of the member is in the sea floor; wherein the laser beam path is positioned in the body of water; wherein the laser beam path is positioned below a sea floor; wherein the laser beam propagated along the beam path is at least about 5 kW; wherein the laser beam propagated along the beam path is at least about 10 kW; wherein the laser beam propagated along the beam path is at least about 15 kW; including hoisting the section from a body of water; including hoisting the section from below a sea floor; including verifying the completion of the cut prior to removing the section; wherein the cut verification is passive; wherein the cut verification is real-time and based at least in part on monitoring the laser beam; and wherein the cut verification is based at least in part on laser range finding.

An offshore method of cutting material associated with an offshore structure including: positioning a high power laser system over a body of water and proximate to the location of the offshore structure, the high power laser system having a high power laser and a high power laser cutter assembly; the high power laser cutting assembly having a high velocity laser jet nozzle, wherein the nozzle is selected from the group consisting of conanda laser jet nozzles and flow through window laser jet nozzles; the high power laser cutter assembly defining a laser beam delivery path for delivery of a high power laser beam along the beam path; propagating a high power laser beam along the beam path, the laser beam having a power of at least 5 kW; and, changing the relative position of the material to be sectioned and the laser beam path in a predetermined laser beam delivery pattern, whereby the laser beam cuts the material in a predetermined cut.

Still further, there is provided these nozzles, systems and methods having one or more of the following features: wherein the predetermined delivery pattern is a continuous ring around the circumference of a tubular; wherein the predetermined cut is a pair of openings for affixing a lifting device; wherein the predetermined cut is a complete cut; including passive verification of the complete cut; wherein the cut verification is real-time and based at least in part on monitoring the laser beam; wherein the laser beam is delivered in a predetermined pattern having a single pass pattern of beam delivery, wherein the laser beam completely severs the material in a single pass of the laser beam.

Moreover, there is provided a method of cutting material associated with an offshore structure including: positioning a high power laser system proximate to the offshore structure in a body of water, the high power laser system having a high power laser optically associated by means of an umbilical with a high power laser cutter assembly; the high power laser cutting assembly having a high velocity laser jet nozzle, wherein the nozzle is selected from the group consisting of conanda laser jet nozzles and flow through window laser jet nozzles; the high power laser cutter assembly defining a laser beam delivery path for delivery of a high power laser beam along the beam path; positioning the beam path below the surface of the body of water; propagating a high power laser beam along the beam path below the surface of the body of water; and, changing the relative position of a member to be cut and the laser beam path, whereby the laser beam strikes the member below the surface of the body of water and thereby cuts the member below the surface of the body of water.

Additionally, there is provided these nozzles, systems and methods having one or more of the following features: wherein the laser beam path when the laser beam is propagated along the beam path is positioned below a seafloor of the body of water; wherein the laser beam path when the laser beam is propagated along the beam path is positioned in a mudline of the body of water; wherein the laser beam path when the laser beam is propagated along the beam path is positioned below a mudline of the body of water; wherein the structure is an oil platform; wherein the structure is a jacket and pile structure; wherein the structure is a monopile structure; wherein the structure is a pipeline; wherein the structure is a bridge support; wherein the member has an inner steel tubular, and an outer steel tubular; wherein the inner steel tubular and the outer steel tubular define an annulus; wherein the annulus is at least partially filled with air; wherein the annulus is at least partially filled with a solid material; wherein the solid material is cement; wherein the laser beam propagated along the beam path strikes an inner tubular positioned within an outer tubular and whereby upon completion of the cutting the inner tubular is severed and the outer tubular is not cut by the laser beam; and, wherein the laser beam propagated along the beam path strikes an inner tubular positioned within an outer tubular and whereby upon completion of the cutting the inner tubular is severed and the outer tubular is severed.

In addition, there is provided a method of plugging and abandoning a well using a high power laser system, the method including: selecting a well, the well having tubulars contained within the well and at least one tubular extending from a location within the well below the surface of the earth to location above the surface of the earth; determining the configuration of at least some of the tubulars; formulating a plugging and abandonment plan for the well based in part upon the configuration of at least some of the tubulars; the plugging and abandonment plan having the steps of: cutting a tubular at a predetermined location within the well and removing the tubular above the cut from the well; placing a plug within the well; cutting and removing all tubulars from the well at least about three feet below the surface of the earth; and, performing at least one of the planned cuts with a high power laser beam delivered from a high velocity laser jet nozzle, wherein the nozzle is selected from the group consisting of conanda laser jet nozzles and flow through window laser jet nozzles.

Still further, there is provided these nozzles, systems and methods having one or more of the following features: wherein a plurality of the planned cuts are performed with a high power laser beam; wherein substantially all of the planned cuts are performed with a high power laser beam; and, wherein the surface of the earth is a sea floor.

Furthermore, there is provided a method of plugging and abandoning a well using a high power laser system, the method including: selecting a borehole in the surface of the earth forming a well, the borehole having a tubular contained therein, the tubular extending below the surface of the earth; placing a first plug within the borehole; cutting the tubular at a location within the borehole and removing at least a some of the cut tubular from the borehole; placing a second plug within the borehole, the second plug being located closer to the surface of the earth than the first plug; delivering a high power laser beam along a beam path to cut all tubulars within the borehole at a second location above the second plug, wherein the laser beam is delivered from a high velocity laser jet nozzle, wherein the nozzle is selected from the group consisting of conanda laser jet nozzles and flow through window laser jet nozzles; wherein the delivery of the laser beam completely severs all tubulars at the location within the borehole; and, removing all of the severed tubulars from the borehole above the second location, wherein the borehole above the second location is free from tubulars.

Moreover, there is provided these nozzles, systems and methods having the laser beam cutting a control line.

Further, there is provided a laser cutting assembly for performing laser operations on a target, the system having: a base; the base having an opening for receiving the target; and an orbital ring; the orbital ring in association with a drive assembly, whereby the orbital ring is configured for orbital motion with respect to the base and around the target when the target is received within the opening; a laser cutting head, the laser cutting head is mechanically attached to the orbital ring at a first location; whereby the laser cutting head defines a laser beam path; a laser beam dump, the laser beam dump is connected to the orbital ring at a second location; whereby the laser beam path extends from the laser cutting head to the laser beam dump; wherein the laser beam path is in contact with the laser beam dump; and, wherein upon orbiting of the orbital ring, the laser beam path remains in contact with the laser beam dump.

Yet further, there is provided these nozzles, systems and methods having one or more of the following features: wherein the base is a split ring; wherein the orbital ring is a split ring; wherein the assembly further has an outer containment housing; wherein the assembly further has an outer containment housing, thereby defining a laser cutting system; whereby the laser cutting system is a Class I product; wherein the assembly further has an outer containment housing, thereby defining a laser cutting system; whereby the laser cutting system is a Class IIa product; wherein the assembly further has an outer containment housing, thereby defining a laser cutting system; and, whereby the laser cutting system is a Class II product.

Additionally, there is provided a method of plugging and abandoning a well using one of these laser cutting assemblies, the method including: selecting a well, the well having tubulars contained within the well and at least one tubular extending from a location within the well below the surface of the earth to location above the surface of the earth; determining the configuration of at least some of the tubulars; formulating a plugging and abandonment plan for the well based in part upon the configuration of at least some of the tubulars; the plugging and abandonment plan including the steps of: cutting a tubular at a predetermined location within the well and removing the tubular above the cut from the well; placing a plug within the well; cutting and removing all tubulars from the well at least about three feet below the surface of the earth; and, performing at least one of the planned cuts with the laser cutting assembly.

### BRIEF DESCRIPTION OF THE DRAWINGS

FIG. 1 is a perspective view on an embodiment of a laser coanda nozzle in accordance with the present inventions.

FIG. 1A is a plan view of the distal end of the laser conanda nozzle of FIG. 1.

FIG. 1B is a cross sectional view of laser conanda nozzle of FIG. 1.

FIG. 1C is a cross sectional view of the laser conanda nozzle of FIG. 1 showing the fluid jet laser beam paths and flow

FIG. 2 is a cross sectional perspective view of an embodiment of a laser head having a by-pass nozzle in accordance with the present inventions.

FIG. 3 is a cross sectional perspective view of an embodiment of a pinch-point nozzle for use with laser heads in accordance with the present inventions.

FIG. 4 is a cross sectional perspective view of an embodiment of a laser head having a conanda nozzle in accordance with the present inventions.

FIG. 5 is a cross sectional perspective view of an embodiment of a laser head having a flow through window nozzle in accordance with the present inventions.

FIG. 5A is a perspective view of the flow through laser window of the laser head of FIG. 5.

FIG. 5B is a cross sectional perspective view of the flow through laser window and laser beam of the laser head of FIG. 5.

FIGS. 6A and 6B are charts comparing embodiments of laser nozzles in accordance with the present inventions with standard nozzles.

FIGS. 7A and 7B are charts comparing embodiments of laser nozzles in accordance with the present inventions with standard nozzles.

FIG. 8 is a perspective view of an embodiment of a laser cutting assembly in accordance with the present inventions.

FIG. 9A is a side plan view of an embodiment of a laser stand with the laser cutting assembly of FIG. 8 in accordance with the present inventions.

FIG. 9B is a perspective view of the stand and cutting assembly of FIG. 9.

FIG. 10 is a perspective view of an embodiment of the stand and cutting assembly of FIG. 9 mounted on, and performing laser operations on, a tubular in accordance with the present inventions.

FIG. 11 is a perspective view of the cutting assembly of FIG. 8 in a breakaway configuration in accordance with the present inventions.

FIG. 12A is a side plan view of the right side of an embodiment of a cover and shielding assembly for a laser cutting tool in accordance with the present inventions.

FIG. 12B is a front plan view of the embodiment of FIG. 12A

FIG. 12C is a top plan view of the embodiment of FIG. 12A.

FIG. 13 is a schematic of an embodiment of a laser cutting tool in accordance with the present inventions.

FIG. 14 is a schematic of an embodiment of a laser cutting tool in accordance with the present inventions.

FIG. 15 is a cross sectional view of a laser cutting tool in accordance with the present invention.

FIG. 15A is a perspective view of the prism assembly of the laser cutting tool of the embodiment of FIG. 15.

FIG. 15B is a perspective view of the motor section of the laser cutting tool of the embodiment of FIG. 15.

FIG. 15C is a perspective view of an embodiment of an integrated umbilical in accordance with the present inventions.

FIG. 16 is a schematic of an embodiment of a laser tool in accordance with the present invention.

FIG. 17 is a schematic of an embodiment of a laser tool in accordance with the present invention.

FIG. 18 is a cross sectional view of an embodiment of an adjustable laser nozzle in accordance with the present inventions.

FIG. 19 is a perspective cross sectional view of the laser nozzle of FIG. 18.

FIG. 20 is a side view of the laser nozzle of FIG. 18.

### DESCRIPTION OF THE PREFERRED EMBODIMENTS

In general, the present inventions relate to tools, systems and methods for performing laser operations on objects, structures, and materials using high power laser energy. In an embodiment, the present inventions generally relate to high power laser methods and systems for performing laser operations on objects, structures and items, which operations generally can include boring holes into, cutting of, sectioning of, softening or weakening of, of these objects, structures or items.

Generally, embodiments of the present inventions relate to high power laser systems, tools and methods for decommissioning oil wells, platforms and other structures relating to the exploration and production of hydrocarbons. In particular, embodiments of the present inventions relate to the cutting and removal of tubulars and other structures associated with offshore oil wells and hydrocarbon production. In particular, embodiments of the present inventions generally relate to the cutting and removal of structures, and their components, for structures such as windmills, bridges, causeways, piers, pipelines, and communication and power cables. Embodiments of the present inventions can also be used in repair, removal and replacement of these structures and components.

Generally, embodiments of the present inventions are directed to tools, systems and methods of: cutting tubulars such as casing or conductors that are located offshore; boring holes in these tubulars for pinning; removing the severed tubulars; and combinations and variation of these. The laser cuts can be done from the outside-in, i.e., the laser beam travels along a laser beam path from the outside, or outer surface, of the tubular toward the inside of the tubular; the laser cuts can be done from the inside-out, i.e., the laser beam travels along a laser beam path from the inside, or inner surface of the tubular, toward the outside of the tubular; and combinations and variations of these.

Although this specification primarily focuses on the decommissioning of offshore oil wells and platforms, the present inventions are not so limited, and the present systems, tools and operations can find application in performing laser operations on land based and other structures and operations both off shore and onshore. Such operations would include cleaning, repair, cutting, replacement, decommissioning, and combinations of these, performed in, on or for, structures and facilities, such as: nuclear facilities, chemical plants, pipelines, bridges, ships, windmills, platforms used for the exploration and production of hydrocarbons; oil and gas wells; oil and gas fields; platforms used to support windmills; structures used to support bridges, causeways or piers; pipelines; and power cables.

Generally, laser cutting uses a laser beam that is directed as a spot to melt the workpiece and a process fluid to push the melted material away. The process fluid can also serve to keep the laser beam path clear, and keep the laser widow or launch point clean, among other purposes. For oil field laser cutting operations, as well as other cutting operations, typically, the process fluid is air or nitrogen gas directed at the cut along with the laser beam (e.g., as a coaxial laser jet). The velocity of the jet, i.e., the process gas, entering the cut effects the clearing potential of the jet, in particular, the clearing ability of the gases forming the jet. For deep cuts this velocity can become a critical factor, in clearing the laser melted material away. Because drag is a function of flow velocity squared, a small change in velocity can have a big impact on cut clearing.

Although this specification focusses on gas jets, i.e. where the processing fluid is a gas, or is in gaseous state, it should be understood that liquids, super critical fluids, and materials in other states may also be used as, or in conjunction with the jet, the processing fluid and both.

Prior tapered nozzles, which are typically used in laser cutting, provide a jet with a flat top velocity profile. Thus, jets from a tapered nozzle having a 0.57″ (14.478 mm) diameter opening, for use with a cut having a width of 0.3″ (0.62 mm), would have the properties as shown in table 1

TABLE 1

| | | | Flow in | | |
|---|---|---|---|---|---|
| Jet | | Distance | scfm (cmpm) | | Well bore |
| Velocity | | from nozzle | (conversion | | pressure |
| mph (kph) | | inches (mm) | at 60 F.) | | psi (kPa) |
| 70 | (112.7) | 1 (25.4) | 150 | (4.248) | 200 (1379.0) |
| 155 | (249.4) | 1 (25.4) | 300 | (8.495) | 200 (1379.0) |
| 230 | (370.1) | 1 (25.4) | 450 | (12.743) | 200 (1379.0) |
| 300 | (482.8) | 1 (25.4) | 600 | (16.990) | 200 (1379.0) |

With these prior nozzles, the velocity of air or nitrogen exiting the nozzle is determined by the nozzle tip diameter, the mass flow rate, and the density of the gas which is a function of wellbore pressure and gas temperature. As wellbore pressure increases, with the prior nozzles velocity quickly drops and the ability to clear a cut diminishes, to the point where unless, exceeding high pressure, volume and flow rate are used, the cut cannot be cleared. With this type of prior nozzle, flow velocity cannot be optimized because the nozzle tip diameter cannot be made smaller without risk of being melted by the laser beam.

The present inventions provide laser jet nozzles that provide high velocity jets in well bore pressure environments. In embodiments, the jets have a flow stream, which could be the entirety of the jet's cross section, or a portion of that cross section within the jet (e.g., a part of the jet, typically the center, or central part of the jet) that have velocities of that are 2×, 3×and 4× greater than the velocities obtained from prior nozzles, under similar conditions (e.g., flow rate, nozzle diameter, cut width, distance from nozzle and flow (scfm (standard cubic feet per minute), cmpm (cubic meter per minute)). Thus, for example, the present inventions provide velocities that are 2×, 3× and greater than the velocities shown in Table 1, under the same conditions as Table 1.

Embodiments of the present inventions provide laser jets having velocities of 600 mph (965.6 kpm), 700 mph (1126.5 kpm) and greater, in for example, 200 psi well bore pressures, at a flow rate of 600 scfm (16.991 cmpm), 500 scfm (14.158 cmpm) and lower. This provides the ability to use lower flow rates, achieve higher velocities, or both, and thus provides greater flexibility in designing laser cutting systems, and in particular systems for oil field and off shore oil field applications. This ability to have equivalent or better clearing, with lower flow rates or the same flow rates, carries across essentially all laser operations, including primarily cutting, piercing, boring, drilling, sectioning, as well as, softening, weakening, melting, annealing, and combinations and variations of these and other operations.

Another advantage of the jets and nozzles of embodiments of the present inventions over prior laser jets and laser jet nozzles, is the ability to have a larger percentage of the jet actually directed to and entering into the cut. In embodiments, the high velocity portion of the jet is smaller than the dimeter of the laser beam, and in this manner essentially all (e.g., 99.999%, about 100%, 99 to 100% at least 95%,) of the high velocity gases, forming the high velocity jet, enter the cut and are available for cut clearing. Further, little to none (e.g., 1% and less, 0.1% and less, 0.01% and less, and 0.001%, and from about 1% to about 0.001% and all values within this range, and smaller amounts) of the high velocity gases of the jet imping upon, or strike, the uncut surface of the metal, or structure being cut.

While this specification focuses primarily on laser operations on metals, it is understood that these laser operations can be performed on other materials, such as ceramics, composites, plastics, rock, the earth, etc.

Typically, once it has been determined that a well is not going to be used, the well will be plugged, and if there is no intention to return to the well, abandoned. By way of example, a laser decommissioning, plugging and abandonment procedure may generally involve some or all, of the following activities and equipment, as well as other and additional activities and equipment. Further decommissioning, laser plugging and abandonment procedures and activities would include, by way of example, the use of high power laser tools, systems, cutters and cleaners to perform any and all of the type of activities that are set forth in BOEMRE 30 CFR 250, subpart Q, and including by way of example, activities such as permanent abandonment, temporary abandonment, plug back to sidetrack, bypass, site clearance and combinations and variations of these. Such activities would further include, without limitation the cutting, removal and modification, and combinations and variations of these, of any structures (below or above the surface of the earth, below or above the surface of the water, below or above the sea floor and combinations and variations of these) for the purpose of temporarily or permanently ceasing or idling activities. Laser decommissioning, plugging and abandonment activities would also include: new activities that were unable to be performed prior to the development of the present high power laser systems, equipment and procedures; existing procedures that prior to the development of the present high power laser systems, equipment and procedures would have been unable to be performed in an economically, safely and environmentally viable manner; and combinations and variations of these.

In general, and by way of example, plugging and abandonment activities may involve the following activities, among others. A cement plug is placed at the deepest perforation zone and extends above that zone a predetermined distance, for example about 100 feet. After the plug has been placed and tested the laser tool is lowered into the well and the production tubing and liner, if present, are cut above the plug and pulled. If there are other production zones, whether perforated or not, cement plugs may also be installed at those locations.

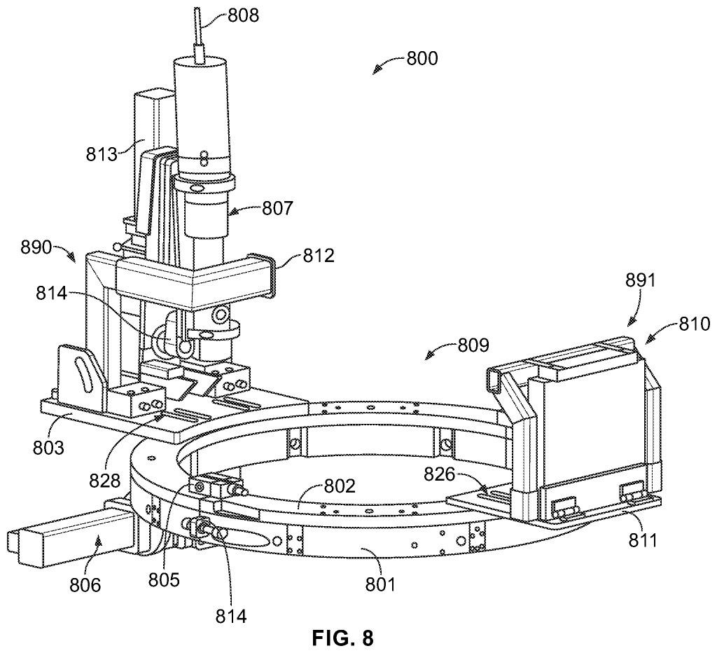

As the production tubing is pulled, it may be cut into segments by a laser cutting device, or it may have been removed before the decommissioning project began, and if jointed, its segments may be unscrewed by pipe handling equipment and laid down. The laser cutting device, e.g., the embodiment of FIGS. 8-12C, may be positioned on the rig floor, in which instance the pipe handling equipment associated with the rig floor can be used to raise and hold the tubing, while the laser cutting device cuts it, remove the upper section of the cut tubing, hold the lower section from falling, and then pull the lower section of tubing into position for the next laser cut. In general, for this type of pulling and cutting operation the laser cutting tool may be located above a holding device, e.g., clamp, spider, rotary, slips and wedges, pins, etc., to hold the pipe and below a hoisting device, such as a crane, top drive and drawworks, to lift the pipe.

A second, or intermediate, cement plug is installed a location above the first plug and in the general area of a shoe of an intermediate and surface casing. Additional intermediate plugs may also be installed. During the installation of these cement plugs, or other cement plugs or activities, to the extent that circulation is needed to be established, or the annulus between tubulars is required to be filled with cement, the laser tool may be used to cut windows or perforations, at predetermined intervals and to predetermined radial depths to establish circulation or provide the ability to selectively fill an annulus with cement. It being understood that these various steps and procedures generally will be based at least in part on the well casing program.

Thus, for example, the laser tool may cut an opening through a 7″ (inch) casing and expose the annulus between the 7″ casing and a larger diameter casing, e.g., 9⅝″ casing. The laser tool may cut an opening through a 13⅜″ casing and expose the annulus between the 13⅜″ casing and a larger diameter casing, e.g., 20″ or 26″ casing. These cuts can for example be made at any depth below the sea floor, or above the sea floor. For example, these cuts could be made at a depth of 10,000 feet, and exposing the annulus around the smaller casing. The laser tool may then cut a second opening at a depth of 10,300 feet exposing the same annulus. This ability to selectively open tubulars and expose various annular spaces in a predetermined and controlled manner may find application in various cleaning, circulating, plugging and other activities required to safely and properly plug and abandoned a well. This ability may also provide benefits to meet future cleaning and plugging regulations or safety requirements. For example, the ability to selectively expose annular space, using the laser tool, and then fill it with cement provides the ability to ensure that no open annular space that extends to the sea floor is left open to the borehole. The ability to selectively expose annular space additionally provides the ability to open or cut windows and perforations in a single piece of casing or multiple pieces of casing at precise sizes and shapes.

In general, any remaining uncemented casing strings, that are located above the top most intermediate plug, may be cut by the laser tool (using internal, external and combinations of both, cuts) and then pulled from the well. (These strings may be segmented by a laser cutting device, at the rig floor as they are being pulled). A top cement plug starting at a fixed depth below the sea floor (e.g., 50 to 100 feet) and extending down into the borehole (e.g., an additional 200-300 feet) is then placed in the well. It being recognized that the cement plug may be added (filled) by flowing from the lower position up, or the upper end position down.

The conductor, and any casings or tubulars, or other materials, that may be remaining in the borehole, are cut at a predetermined depth below the seafloor (e.g., from 5 to 20 feet, and preferably 15 feet) by the laser cutting tool. Once cut, the conductor, and any internal tubulars, are pulled from the seafloor and hoisted out of the body of water, where they may be cut into smaller segments by a laser cutting device at the rig floor, vessel deck, work platform, or an off-shore laser processing facility. Additionally, biological material, or other surface contamination or debris that may reduce the value of any scrap, or be undesirable for other reasons, may be removed by the laser system before cutting and removal, after cutting and removal or during those steps at the various locations that are provided in this specification for performing laser operations. Holes may be cut in the conductor (and its internal cemented tubulars) by a laser tool, large pins may then be inserted into these holes and the pins used as a lifting and attachment assembly for attachment to a hoist for pulling the conductor from the seafloor and out of the body of water. As the conductor is segmented on the surface additional hole and pin arrangements may be needed.

This process may then be repeated, or carried out in parallel, with other wells that are to be plugged and abandoned. Thus, using a laser plugging and abandonment process conductors can be cut about 15 feet below the seafloor, removed, segmented and cleared from the platform site. There can be one, two, ten, 50 or more, conductors associated with a single platform and that some, most or all of them may be removed and their associated wells plugged and abandoned using laser plugging and abandonment procedures. The laser cutting tool may cut at any depth below the sea floor, below the surface of the water, above the surface of the water, and may cut any predetermined number of tubulars that are concentric, eccentric, irregular shape from for example damage, and combinations and variations of these. The depth of the cut will be determined among other things by the regulations governing the decommissioning project, the seafloor conditions, and the lifting capacity of the hoisting equipment.

It is contemplated that internal, e.g., inside out, external, e.g., outside in, and combinations of both types of cuts be made on multi-tubular (e.g., multi-string) configurations, e.g., one tubular located within the other. The tubulars in these multi-tubular configurations may be concentric, eccentric, concentrically touching, eccentrically touching at an area, have grout or cement partially or completely between them, have mud, water, or other materials partially or completely between them, and combinations and variations of these. In wells, and oil field infrastructure, control lines, hydraulic lines, and other types of lines can be present. The laser cutting tools and systems of the present inventions can be sued to cut these lines, and preferably cut these lines as they are cutting the tubulars in the well.

Additionally, the laser systems provide an advantage in crowded and tightly spaced conductor configurations, in that the precision and control of the laser cutting process permits the removal, or repair, of a single conductor, without damaging or effecting the adjacent conductors. Thus, in addition to decommissioning and abandonment operations, embodiments of the present inventions include and find application in, repair, replacement, and maintenance operations, and combinations and variations of these.

The forgoing examples of high power laser plugging and abandonment activities is meant for illustration purposes only and is not limiting, as to either the sequence or general types of activities. Those of skill in the plugging and abandonment arts, will recognize that there are many more and varied steps that may occur and which may occur in different sequences during a plugging and abandonment process. For example, the borehole between cement plugs may be filled with appropriately weighted fluids or drilling muds. Many of these other activities, as well as, the cutting, segmenting, and plugging activities of the forgoing example, are dictated by the particular and unique casing and cement profile of each well, seafloor conditions, regulations, and how the various tubulars have aged, degraded, or changed over the life of the well, which could be 10, 20, or more years old.

The high power laser systems, methods, down hole tools and cutting devices, provide improved abilities to quickly, safely and cost effectively address such varied and changing cutting, cleaning, repairing, decommissioning and plugging requirements that may arise during the plugging and abandonment of a well. These high power laser systems, methods, down hole tools and cutting devices, provide improved reliability, safety and flexibility over existing methodologies such as explosives, abrasive water jets, milling techniques or diamond band saws, in the laser's systems ability to meet and address the various cutting conditions and requirements that may arise during a plugging and abandonment project. In particular, and by way of example, unlike these existing methodologies, high power laser systems and processes, will not be harmful to marine life, and they will ensure a complete and rapid cut through all types of material. Unlike an explosive charge, which sound and shock waves, may travel many miles, the laser beam for specific wavelengths, even a very high power beam of 20 kW or more, has a very short distance, e.g., only a few feet, through which it can travel unaided through open water. Unlike abrasive water jets, which need abrasives that may be left on the sea floor, or dispersed in the water, the laser beam, even a very high power beam of 20 kW or more, is still only light; and uses no abrasives and needs no particles to cut with or that may be left on the sea floor or dispersed in the water.

In addition to decommissioning, the laser tools can be used to repair a well, such as by removal of a stuck tool, or obstruction, e.g., pinched or damaged casing, from a well. To the extent that there are any tools, valves, obstructions (e.g., bend or damages casings, production tubing), or other downhole equipment, that are required or desirable to be removed, but which are stuck downhole or otherwise obstructing the well, the a laser cutting tool and laser tool umbilical (or the umbilical may be used without the need for a separate or additional line, e.g., a wireline, depending upon the umbilical and laser module), to the location of the obstruction or stuck downhole equipment. The laser tool will deliver a high power laser beam to the stuck downhole equipment or obstruction, cutting the equipment or obstruction to sufficiently free it for recovery, by the laser tool or the line, completely melting or vaporizing the stuck equipment, and thus, eliminating it as an obstruction, or combinations and variations of these. Any damage to the well can then be repaired and the well can then be pressure tested and any fluid communication between tubular annular spaces is evaluated.

It is noted that the laser removal system, methods, tools and devices of the present inventions may be used in whole, or in part, in conjunction with, in addition to, or as an alternative, in whole, or in part, to existing methodologies for the removal of offshore structures without departing from the spirit and scope of the present inventions. Further, it is noted that the laser removal system, methods, tools and devices of the present inventions may be used in whole, or in part, in conjunction with, in addition to, or as an alternative, in whole or in part, to existing methodologies to remove or repair only a portion of an offshore structure without departing from the spirit and scope of the present inventions. Additionally, it is noted that the sequence or time of the various steps, activities and methods or removal (whether solely based on the laser removal system, methods, tools and devices or in conjunction with existing methodologies) may be varied, repeated, sequential, consecutive and combinations and variations of these, without departing from the spirit and scope of the present inventions.

It is preferable that the assemblies, conduits, support cables, laser cutters and other subsea components associated with the operation of the laser cutters, should be constructed to meet the pressure and environmental requirements for the intended use. The laser cutter head and optical related components, if they do not meet the pressure requirements for a particular use, or if redundant protection is desired, may be contained in or enclosed by a structure that does meet these requirements. For deep and ultra-deep water uses the laser cutter and optics related components should preferably be capable of operating under pressures of 1,000 psi, 2,000 psi, 4,500 psi, 5,000 psi or greater. The materials, fittings, assemblies, useful to meet these pressure requirements are known to those of ordinary skill in the offshore drilling arts, related sub-sea Remote Operated Vehicle (“ROV”) arts.

The laser cutting tools may also have monitoring and sensing equipment and apparatus associated with them. Such monitoring and sensing equipment and apparatus may be a component of the tool, a section of the tool, integral with the tool, or a separate component from the tool but which still may be operationally associated with the tool, and combinations and variations of these. Such monitoring and sensing equipment and apparatus may be used to monitor and detect, the conditions and operating parameters of the tool, the high power laser fiber, the optics, any fluid conveyance systems, the laser cutting head, the cut, and combinations of these and other parameters and conditions. Such monitoring and sensing equipment and apparatus may also be integrated into or associated with a control system or control loop to provide real time control of the operation of the tool. Such monitoring and sensing equipment may include by way of example: the use of an optical pulse, train of pulses, or continuous signal, that are continuously monitored that reflect from the distal end of the fiber and are used to determine the continuity of the fiber; the use of the fluorescence and black body radiation from the illuminated surface as a means to determine the continuity of the optical fiber; monitoring the emitted light as a means to determine the characteristics, e.g., completeness, of a cut; the use of ultrasound to determine the characteristics, e.g., completeness, of the cut; the use of a separate fiber to send a probe signal for the analysis of the characteristics, e.g., of the cut; and a small fiber optic video camera may be used to monitor, determine and confirm that a cut is complete. These monitoring signals may transmit at wavelengths substantially different from the high power signal such that a wavelength selective filter may be placed in the beam path uphole or downhole to direct the monitoring signals into equipment for analysis.

To facilitate some of these monitoring activities an Optical Spectrum Analyzer or Optical Time Domain Reflectometer or combinations thereof may be used. For example, an AnaritsuMS9710C Optical Spectrum Analyzer having: a wavelength range of 600 nm-1.7 microns; a noise floor of 90 dBm @ 10 Hz, −40 dBm @ 1 MHz; a 70 dB dynamic range at 1 nm resolution; and a maximum sweep width: 1200 nm and an Anaritsu CMA 4500 OTDR may be used.

In an embodiment a USB spectrometer can be used to monitor laser operations and activities, such as cutting. These spectrometers are compact and can be ruggedized. These spectrometers can be obtained for example from OCEAN OPTICS.

The efficiency of the laser's cutting action, as well as the completion of the cut, can also be determined by monitoring the ratio of emitted light to the reflected light. Materials undergoing melting, spallation, thermal dissociation, or vaporization will reflect and absorb different ratios of light. The ratio of emitted to reflected light may vary by material further allowing analysis of material type by this method. Thus, by monitoring the ratio of emitted to reflected light material type, cutting efficiency, completeness of cut, and combinations and variation of these may be determined. This monitoring may be performed uphole, downhole, or a combination thereof. Further, a system monitoring the reflected light, the emitted light and combinations thereof may be used to determine the completeness of the laser cut. These, and the other monitoring systems, may be utilized real-time as the cut is being made, or may be utilized shortly after the cut has been made, for example during a return, or second rotation of the laser tool, or may be utilized later in time, such as for example with a separate tool.

In a preferable embodiment a potosensor-photoresistor or photodiode is located in the downhole connector, the downhole tool head or both. These devices can be used to determine if the laser tool is cutting metal (e.g., steel) vs cement (e.g., concrete), as well as if a complete cut has been obtained.

A preferable embodiment of a system for monitoring and confirming that the laser cut is complete and thus that the laser beam has severed the member, is a system that utilizes the color of the light returned from the cut can be monitored using a collinear camera system or fiber collection system to determine what material is being cut. In the offshore environment it is likely that this may not be a clean signal. Thus, and preferably, a set of filters or a spectrometer may be used to separate out the spectrum collected by the downhole sensor. This spectra can be used to determine in real-time, if the laser is cutting metal, concrete or rock; and thus provide information that the laser beam has penetrated the member, that the cut is in progress, that the cut is complete and thus that the member has been severed.

The conveyance structure may be: a single high power optical fiber; it may be a single high power optical fiber that has shielding; it may be a single high power optical fiber that has multiple layers of shielding; it may have two, three or more high power optical fibers that are surrounded by a single protective layer, and each fiber may additionally have its own protective layer; it may contain or have associated with the fiber a support structure which may be integral with or releasable or fixedly attached to optical fiber (e.g., a shielded optical fiber is clipped to the exterior of a metal cable and lowered by the cable into a borehole); it may contain other conduits such as a conduit to carry materials to assist a laser cutter, for example gas, air, nitrogen, oxygen, inert gases; it may have other optical or metal fiber for the transmission of data and control information and signals; it may be any of the combinations and variations thereof.

The conveyance structure transmits high power laser energy from the laser to a location where high power laser energy is to be utilized or a high power laser activity is to be performed by, for example, a high power laser tool. The conveyance structure may, and preferably in some applications does, also serve as a conveyance device for the high power laser tool. The conveyance structure's design or configuration may range from a single optical fiber, to a simple to complex arrangement of fibers, support cables, shielding on other structures, depending upon such factors as the environmental conditions of use, performance requirements for the laser process, safety requirements, tool requirements both laser and non-laser support materials, tool function(s), power requirements, information and data gathering and transmitting requirements, control requirements, and combinations and variations of these.

The conveyance structure may be, for example, coiled tubing, a tube within the coiled tubing, wire in a pipe, fiber in a metal tube, jointed drill pipe, jointed drill pipe having a pipe within a pipe, or may be any other type of line structure, that has a high power optical fiber associated with it. As used herein the term “line structure” should be given its broadest meaning, unless specifically stated otherwise, and would include without limitation: wireline; coiled tubing; slick line; logging cable; cable structures used for completion, workover, drilling, seismic, sensing, and logging; cable structures used for subsea completion and other subsea activities; umbilicals; cables structures used for scale removal, wax removal, pipe cleaning, casing cleaning, cleaning of other tubulars; cables used for ROV control power and data transmission; lines structures made from steel, wire and composite materials, such as carbon fiber, wire and mesh; line structures used for monitoring and evaluating pipeline and boreholes; and would include without limitation such structures as Power & Data Composite Coiled Tubing (PDT-COIL) and structures such as those sold under the trademarks Smart Pipe® and FLATpak®.

High powered laser systems, conveyance structures and handling apparatus are disclosed and taught in U.S. Pat. Nos. 8,826,973, 8,571,368, 8,662,160, 9,089,928, 9,347,271, 9,492,885, and 9,664,012, the entire disclosure of each of which are incorporated herein by reference.

The laser cutting tools and devices that may be utilized for the present removal methods and with, or as a part of, the present removal systems, in general, may have a section for receiving the high power laser energy, such as for example, from a high power connector on a high power fiber, or from an umbilical having a fluid path and a high power fiber. Although single fiber tools and devices are described herein, it should be understood that a cutting tool or device may receive high power laser energy from multiple fibers. In general, the laser cutting tools and devices may have one, or more, optics package or optics assemblies, which shape, focus, direct, re-direct and provide for other properties of the laser beam, which are desirable or intended for a cutting process. Embodiments of high power laser optics packages are disclosed and taught in U.S. Pat. Nos. 8,424,617, 9,399,269, 9,664,012, and 9,669,492, the entire disclosure of each of which are incorporated herein by reference.

In general, the laser cutting assemblies systems and tools of the present inventions can use a fluid jet in conjunction with the laser beam for cutting in fluid, e.g., subsea, in a borehole with drilling fluid, and optionally for cutting in air. The laser fluid jet cutting heads find greater applicability and benefit in cutting applications that are being conducted in, or through, a liquid or debris filled environment, such as e.g., an outside-to-inside cut where sea water is present, or an inside-to-outside cut where drilling mud is present. The fluid for the fluid jet may be a liquid or gas. Thus, for example, the jet can be for example air, oxygen, nitrogen, argon, D₂O, water, or other cutting gases or fluids.

In an embodiment of a high velocity low flow rate jet of the present inventions is a coanda laser jet nozzle. Generally, a coanda laser jet nozzle, (the coanda nozzle) can be used to improve flow velocity at higher wellbore pressures or cutting environment pressures, reduce the volume of processing fluid needed at lower wellbore or cutting environment pressures, and combinations and variations of these. It directs a gas, e.g., air, through thin slots outside of the laser beam cavity and focuses the air in line with the laser beam utilizing the coanda effect. This allows the slots to be sized such that the desired airflow velocity is achieved at a target flow rate and wellbore pressure. In these embodiments the majority of the gas is focused into a jet having a diameter that is smaller than the width of the cut. In this manner there is a more effective and efficient use of the gas and the force created by the gas jet.

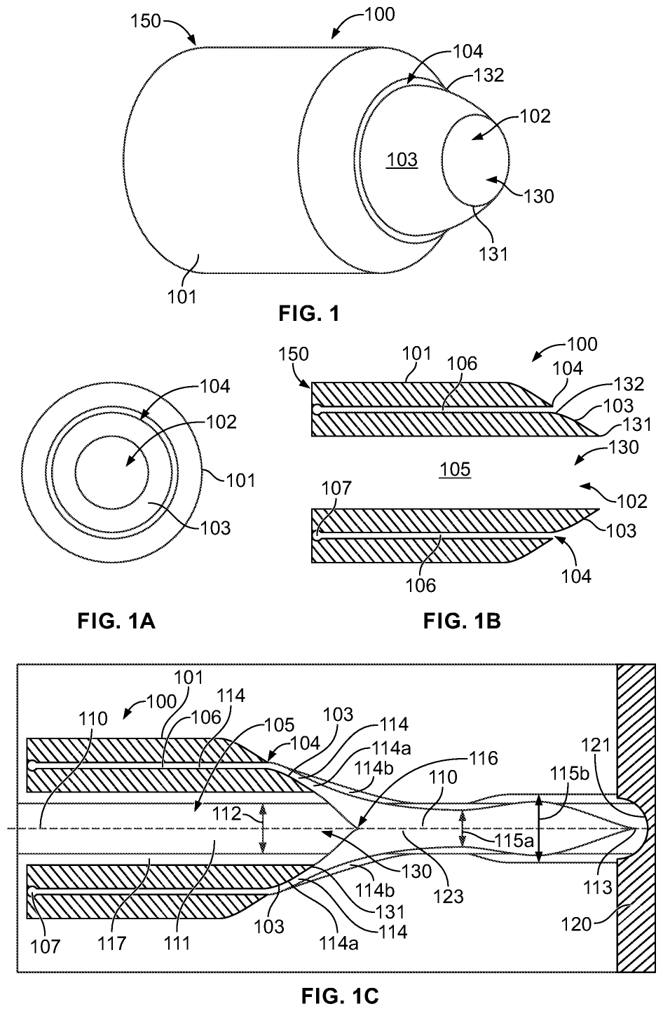

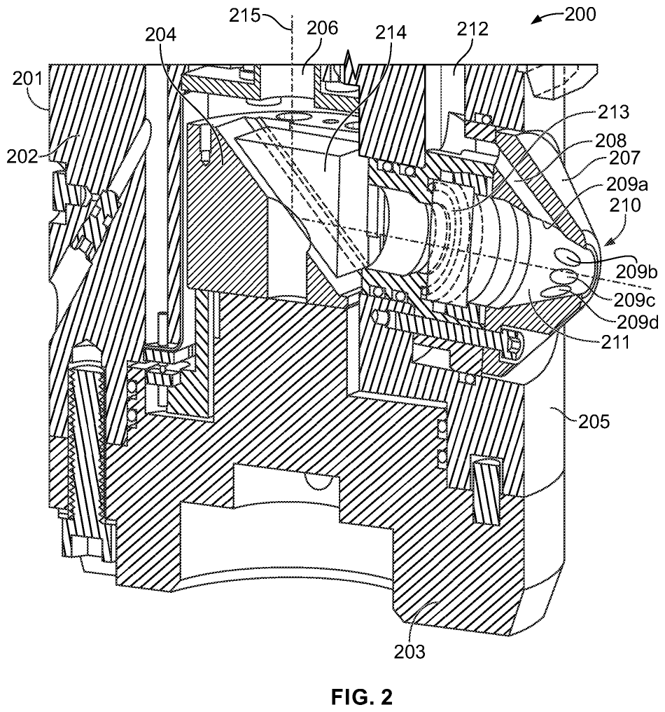

Turning to FIGS. 1, and 1A to 1C there is a provided various views of an embodiment of a coanda laser jet nozzle 100. The laser jet nozzle 100 has a body 101 that has a central opening 102 where the laser beam path and laser beam exists the nozzle 100. Thus, central opening 102 may also be referred to as laser beam opening or exit. The nozzle 100 has a coanda surface 103, which is a tapered conical surface, which in this embodiment extends from an annular opening 104 to and forms open 102.

The coanda surface 103 has a proximal end 132 and a distal end 131. The nozzle 100 has a distal end 130, and a proximal end 150. In this embodiment the distal end 130 of nozzle 100 is the distal end 131 of the coanda surface 103 and opening 102.

In operation, and generally, the fluid for the fluid jet exits annular opening 104, and is formed into an annular fluid jet (traveling distally, i.e., from opening 104 to toward opening 102) this annular fluid jet hugs, e.g., follows along the coanda surface 103 (because of the coanda effect), and then flows into the laser beam path where the annular jet combines, (in effect collapses) form an annular stream into a circular stream.

Turning to FIG. 1B, there is a cross section of the coanda laser jet nozzle 100. The coanda surface 103 has a proximal end 132 and a distal end 131. The nozzle 100 has a distal end 130, and a proximal end 150. In this embodiment the distal end 130 of nozzle 100 is the distal end 131 of the coanda surface 103 and opening 102. The annular opening 104 is in fluid communication with an annular channel 106 that supplies the jet fluid, e.g., air, N₂, to the annular opening 104. The annular channel 106 is in fluid communication with a fluid inlet 107, which in turn is in fluid communication with the jet fluid source (not shown). In this manner the fluid used for the fluid jet flows from is source (through other piping or channels, not shown) to the fluid inlet 107, where it enters annular channel 106, exits annular opening 104, and flows as an annular jet along coanda surface 103. The nozzle 100 has a laser beam channel 105. The laser beam path is present in this channel 105, and the laser beam is present and travels, along the laser beam path, through this channel and exist at opening 102, where the laser beam (distally of the opening 102) is combined with the annular jet as it forms into a circular jet (e.g., the jet has a generally circular cross section, is filled with flowing fluid and thus has no void or opening in its center, although as described below in embodiments the circular jet can have fluid flowing at different rates across the diameter or cross section of the jet).

Turning to FIG. 1C there is shown a cross section of the coanda laser jet nozzle 100 in operation. The laser beam 111 is propagated along laser beam path 110. The laser beam 111 is within laser beam channel 105 and exits the nozzle 100 through the distal end 130 opening 102 and continues to travel along laser beam path 110 to a target material 120. The laser beam 111 has a beam diameter, within the channel 105, as shown by arrow 112.

The laser beam diameter can be about 0.5 mm, about 1 mm, about 1.5 mm, about 2 mm, about 10 mm, about 14.5 mm, about 15 mm, about 17 mm, greater than 0.5 mm, greater than 1 mm, greater than 1.5 mm, from about 0.5 mm to about 5 mm, from about 10 mm to about 17 mm, from about 7 mm to about 17 mm, from about 0.5 mm to about 20 mm, greater and smaller diameters, and sizes across these values, are contemplated. The laser beam spot 113 will have size, e.g., diameter, at the target 120 that will have the same or similar sizes within the ranges of sizes for the beam diameter 112. It being understood that depending on the optics be used the beam diameter 112 can remain the same as it travels out of the nozzle 100 and strikes the target 120, if can reduce as the beam is focused to a spot having a smaller diameter than diameter 112, or it could expand if the beam is expanding.

The channel 105 has a pressurized gas 117 flowing within the cavity. The gas prevents the inflow of fluid, debris, or other material from entering the nozzle channel 105.

The annular opening 104 forms an annular jet 114 that hugs coanda surface 103 and travels distally along that surface to the distal end 131 of the coanda surface 103. The annular high pressure high velocity jet leaves the distal end 131 of the coanda surface 103 and begins to converge to a solid or circular jet and a point 116, where the central opening or void in the annular jet has been completely filled in with fluid, and the jet has flowing fluid across the entirety of its diameter. The annular jet 103 leaves the distal end of the coanda surface 131 and enters the laser beam 111, forming a laser beam jet. It is noted that point 116, where the circular jet is formed, is distally removed from the nozzle end 130. The coalesced circular jet is preferably coaxial with the laser beam, thus the laser beam path 110 and the coalesced jet path 123 are preferably coaxial. (Regarding FIG. 1C for clarity, lines 110 and 123 are co-axial, with line 123 beginning at point 116 and extending toward the distal end of the nozzle.) After the jet leaves orifice 104 it will develop different velocity flows within in it, with the slowest velocities being toward the outer surface of the jet. For the purposes of illustration only two flows are being shown, a high velocity flow 114a and a lower velocity flow 114b. As the annular jet 103 coalesces, or forms, into the circular jet at point 116, the high velocity flow 114a has a diameter 115a that is smaller than the diameter of the laser beam. Preferably, the nozzle is configured such that the high velocity flow is contained within the laser beam, and entirely contained within the laser beam (i.e., the high velocity flow is coaxial along the laser beam path, and has a diameter that smaller than the laser beam diameter) from the coalesces point 116, to and at the target 120. In this manner the high velocity jet has a diameter or size that is small than the size (e.g., diameter, cross section) of the cut 121 in the target material 120, and has a diameter or size that is smaller than the laser beam spot 113. The lower velocity portion of the jet 114b has a diameter or size 115b that is larger than the laser beam spot 113, and larger than the cut 121, and larger than the laser beam diameter at some points along the laser beam path.

In embodiments the high velocity flow 114a can have speeds of 350 mph, (which is over twice the speed of a prior tapered nozzle, under the same conditions) 400 mph, 500 mph, 600 mph and greater for a diameter 1115a of about 1 inch, at about 1 inch from the distal end of the nozzle, e.g., the nozzle tip, with a well bore pressure of 200 psi, by way of example. Thus, velocities of from 350 mph to 600 mph are contemplated.

The opening 102 preferably has a diameter of 0.57 inches (14.478 mm) and can have diameters of about 0.5 mm, about 1 mm, about 1.5 mm, about 2 mm, about 10 mm, about 14.5 mm, about 15 mm, about 17 mm, greater than 0.5 mm, greater than 1 mm, greater than 1.5 mm, from about 0.5 mm to about 5 mm, from about 10 mm to about 17 mm, from about 7 mm to about 17 mm, from about 0.5 mm to about 20 mm, greater, and sizes across these values, as well as, greater and smaller diameters. It being understood that the diameter of the channel 105 and opening 102 are preferably the same.

The coanda nozzle design can provide jet flows that allow for clean leaser cutting and piercing of targets, e.g., tubulars at external pressures (e.g., subsea, within a tubular) of about 200 psi and greater, about 400 psi and greater, about 500 psi and greater, about 750 psi and greater, about 1000 psi, from about 200 psi to about 1,000 psi, and all values within these ranges, as well as greater and smaller pressures.

The coanda nozzle provides high power jets for use with high power laser beams. In preferred embodiments the nozzle provides a high power jet wherein the diameter of the high velocity jet portion of the jet is smaller than the diameter of the laser beam.

In an embodiment of a coanda laser jet nozzle the nozzle provides a gas jet having a high velocity central stream having a velocity of 600 mph, at 200 psi well bore pressure, at 1 inch from the distal end of the nozzle, and with 600 scfm flow rate. The high velocity center stream has a diameter of about 0.2″ and clears a laser cut having a width of 0.15″.

Turning to FIG. 2 there is an embodiment of a FIG. 2 is a cross sectional perspective view of an embodiment of a laser head having a by-pass nozzle in accordance with the present inventions. Thus, the laser head 200 has a body 201. The body having an upper part 202 and a lower part 203. The upper part 202 and the lower part 203 and held together by for example screws, bolts, clip, etc. There is a prism support 204, that is preferably in the upper part 202, but may be located in the lower part 203. The prism support 204 holds a prism 214, which is reflective. In operation a laser beam will travel along laser beam path 215, enter and be directed by prism 214, through pressure window 213 into the bypass nozzle 207. There is also a beam guide 206 in the upper section, through which a part of the laser beam path 215 is found. There is a face section 205, which is located in the upper section 202, and the face section 205 also abuts or is adjacent to the lower section 203. The bypass nozzle 207 is held by, or positioned in the face section 205.

The bypass nozzle has channels 208 through which the gas for the jet flow. The channels have internal openings 209a, 209b, 209c, 209d, that are formed in the nozzle inner surface 211. These internal openings 209a, etc., permit the gas to flow into the nozzle passage, and form a jet that is coincident with the laser beam path 215. The jet, thus formed and the laser beam, traveling along laser beam path 215, exit the nozzle through nozzle opening or exist, 210.

In this manner a high pressure, low flow jet is formed that is coincident with the path of the laser beam and the laser beam itself. The jet and laser beam will impinge upon and cut a target material along the laser beam path. This bypass nozzle can provide high velocity jets for high power laser beams.

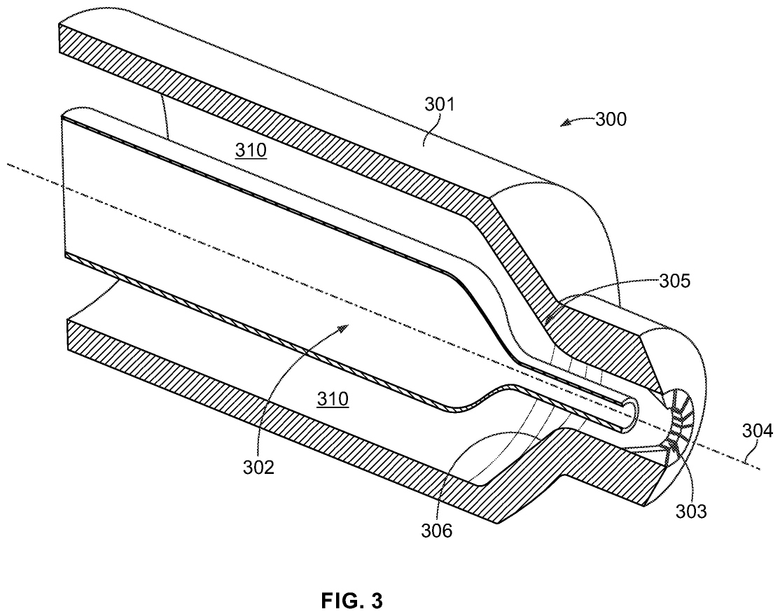

FIG. 3 is an embodiment of pinch nozzle 300. In this embodiment, the nozzle 300 has an outer body 301. Formed within the outer body is an annular channel 310, that surrounds an inner channel 302. Both channels narrow, in area 305 (a restriction or pitch area) as they approach the nozzle exit opening 303. The fluid for forming the jet flows through annular channel 305, and may also flow through channel 302. The laser beam travels along laser beam path 304, which is in the inner channel 302.

In embodiments of the nozzles, it can be advantage to have the cutting fluid not directly flowing over the window. In this manner contamination in the cutting fluid will not contaminate the window.

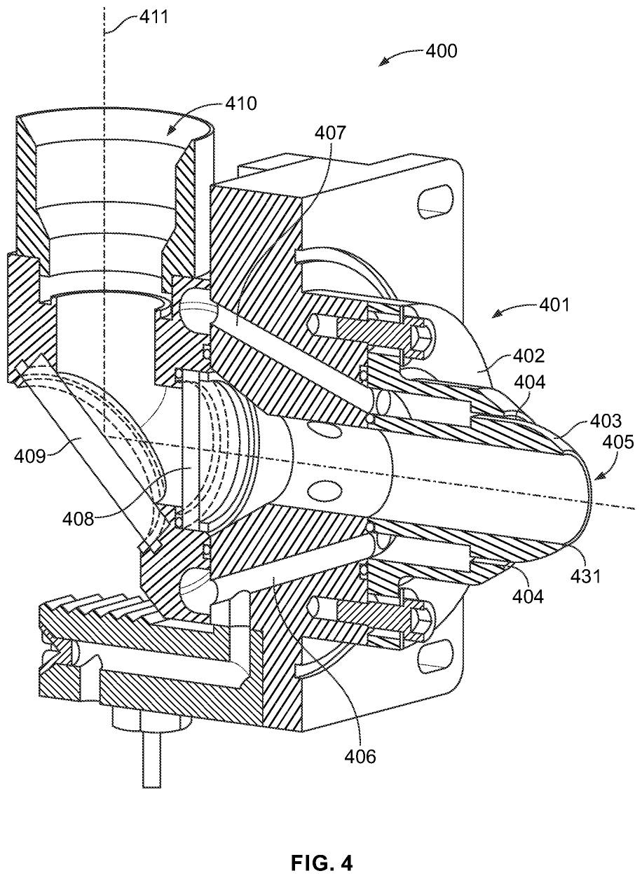

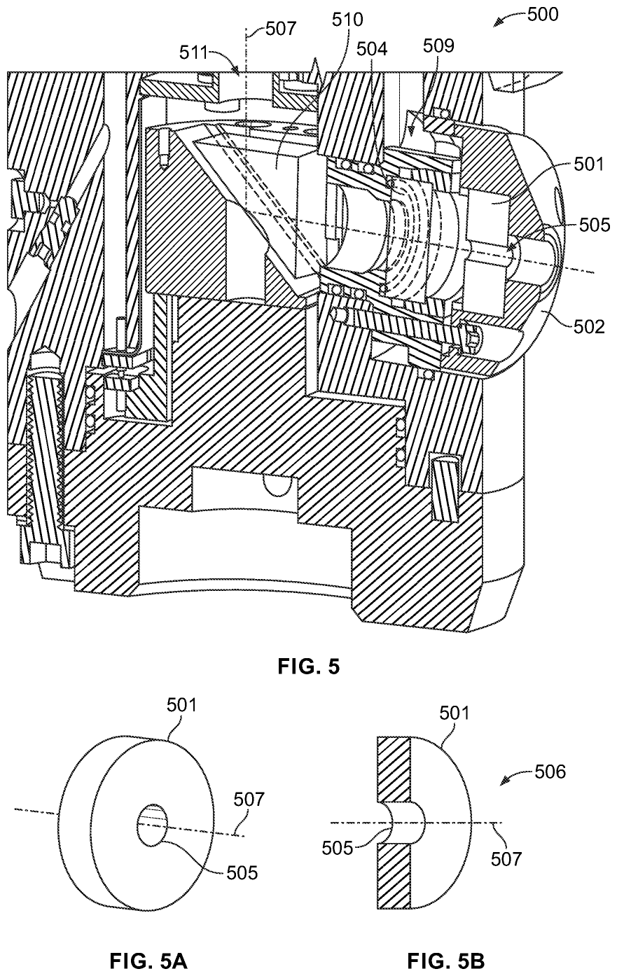

Turning to FIG. 4 is a cross sectional perspective view of an embodiment of a laser head 400 having a conanda nozzle in accordance with the present inventions. The laser head 400 has a conanda nozzle assembly 401, which has a conanda nozzle 402. The conanda nozzle 402 has a conanda nozzle surface 403 that adjacent to the annular jet opening, and forms a surface or path for the jet to flow along or over, to the nozzle exit opening 405. The nozzle 402 has a fluid channels 406 and 407 for providing fluid to the annular opening 404. The laser head 400 has a pressure window 408, and a reflective optic 409. The laser beam path is shown by dashed line 411, and in operation a high power laser beam would travel along the laser beam path 411. The nozzle opening is in the face 431 of the nozzle 402. An embodiment of FIG. 4 could utilize the conanda nozzle of the type shown in FIG. 1.

Turning to FIGS. 5, and 5A to 5B, this is shown respectively a cross sectional perspective view of an embodiment of a laser head having a flow through window nozzle in accordance with the present inventions; a perspective view of the flow through laser window; and a cross sectional perspective view of the flow through laser window with a laser beam being transmitted through the window and a high velocity jet being formed by the window.

In this embodiment a transmissive element, through which the laser beam, preferably a high power laser beam, is being transmitted, also forms the high velocity fluid jet. Further, and preferably, in this embodiment the high velocity fluid jet is narrower, i.e., has a smaller diameter than the diameter of the laser beam.

The laser head 500 has a jet window 501. The jet window is distal to the nozzle 502, when viewed along the laser beam path 507. The jet window, however, could be locate more proximal or distal along the laser beam path 507. The laser beam path 507, along which the high power laser beam travels in operation, goes from a laser beam channel 511 to a reflective optic 510 through the jet window 501, and exits the nozzle the nozzle exit opening.

A fluid channel 509 provides a channel for flowing the processing fluid, e.g., gas, through the laser head and into the laser beam channel, behind, or proximal to the window. Thus, as seen in FIG. 5B the laser beam 507 traveling along laser beam path 507, is transmitted through the window 504. The window has an orifice 505, preferably located on, and coaxial with the laser beam and the laser beam path. (The orifice can be located at or near the center of the laser beam path.) The fluid passes through the orifice 505, forming a high velocity jet within the laser beam. In this manner the high velocity jet and laser beam exit the nozzle through the nozzle exit opening.

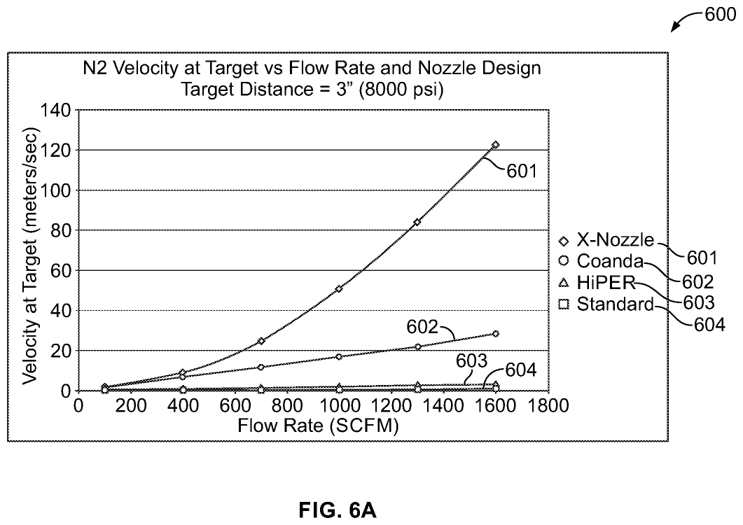

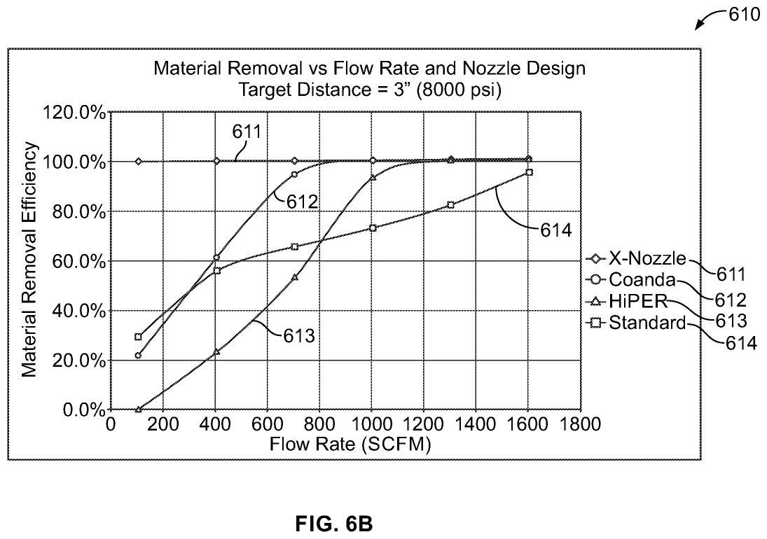

Turning to FIG. 6A there is shown a chart of the velocity of nitrogen gas flow (meters per second) vs flow rate (scfm) for the nozzles of the embodiments of FIGS. 1, 2, 3 and 4, compared to a prior standard gas nozzle. The velocities are measured at a target distance of 3 inches (i.e., distance from the end or tip of the nozzle), and in an environment of 8,000 psi. The prior standard gas nozzle performance of the gas is shown by line 604. The performance of the pinch-point nozzle of the embodiment of FIG. 2, is shown by line 603. It can be seen that there is very little improvement over the standard nozzle. The performance of the conanda nozzle of the type shown in FIG. 1 is shown by line 602. It can be seen that the conanda type nozzle has a significant a velocity increase for given flow rate over both the pinch-point and standard nozzles. The flow through window nozzle, of the type shown in FIG. 5, has a performance shown by line 601. It can be seen that the flow through nozzle has significantly superior flow velocities for a given flow rate than the other embodiments of nozzles. Moreover, the flow through window nozzle design, exhibits an exponential increase in velocity with increasing flow.

FIG. 6B shows the efficiency of material removal, e.g., removal of dross, for these embodiments of the nozzle types. Similarly, at a target distance of 3 inches, and environment of 8,000 psi. The percentage removal efficiency for the flow through window is shown by line 611, the efficiency for the conanda type nozzle is shown by line 612, the efficiency of removal for the pinch-point nozzle is shown by line 613, and the efficiency of removal for the standard type nozzle is shown by line 614.

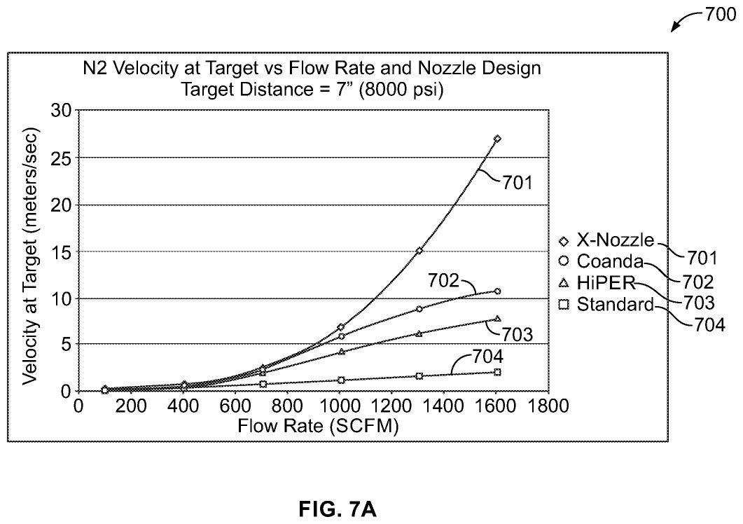

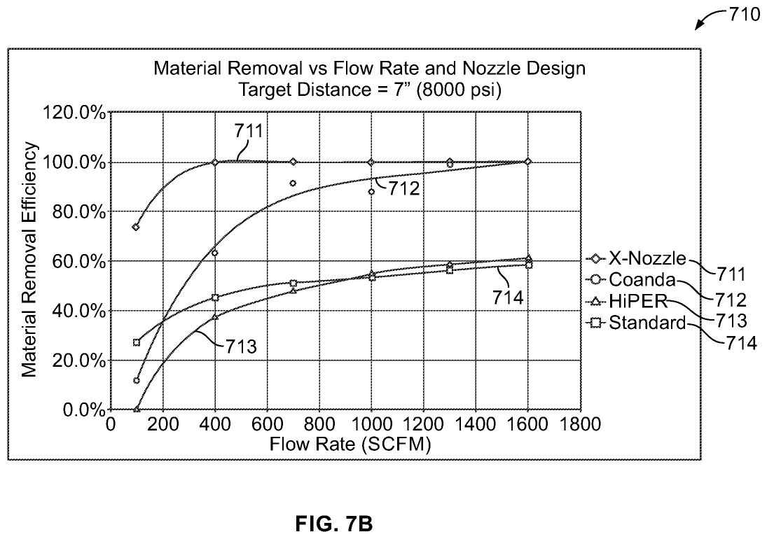

Similar data is shown for these nozzles in FIGS. 7A and 7B, for a target distance of 7 inches. In FIG. 7A, line 704 is for the standard nozzle, line 703 is for the pinch-point type nozzle, line 702 is for the conanda type nozzle, and line 701 is for the flow through window type nozzle. In FIG. 7B, line 714 if for the standard type nozzle, line 713 is for the pinch-point type nozzle, line 712 is for the conanda type nozzle, and line 711 is for the flow through window type nozzle.

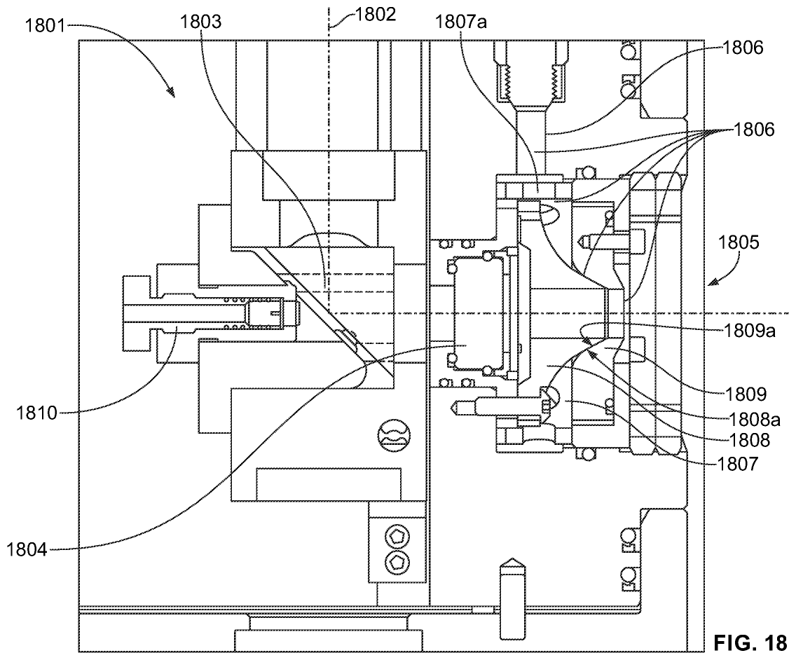

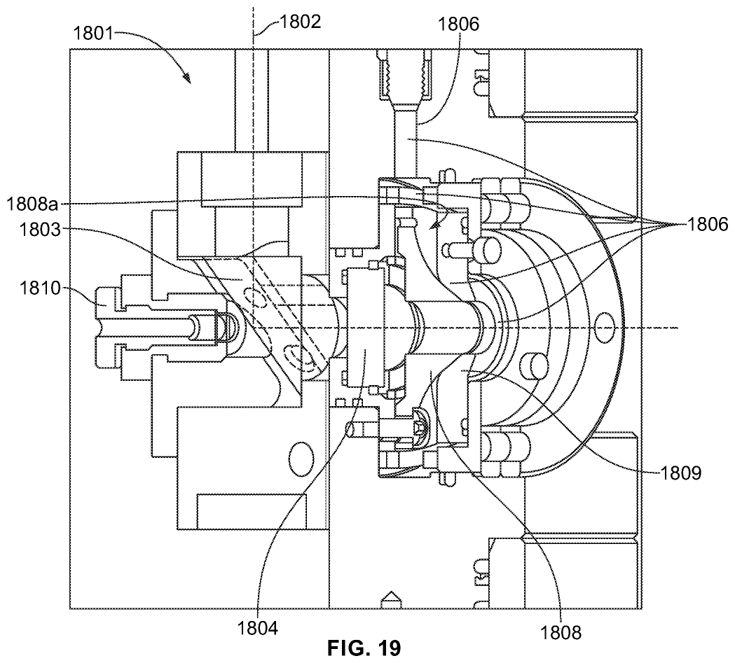

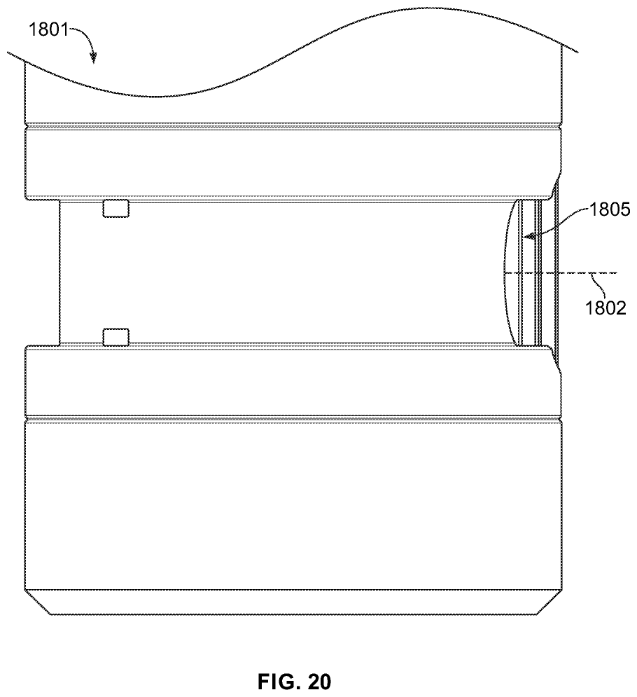

A further embodiment of a high velocity laser jet includes an adjustable nozzle embodiment of the type shown in FIGS. 18 to 20.

Turning to FIGS. 18 to 20 there is a side cross sectional view of an adjustable nozzle 1801, a perspective cut away view of this nozzle and a side view of this nozzle, respectively. The nozzle 1801 has a laser beam path 1802, along with a laser beam (not shown) travels. The laser beam path passes through a prism 1803, a window 1804 and exist through an opening 1805. There is a fluid flow path 1806, that is defined by an inlet or infeed channel or tube 1806, a ring structure 1807 having a series of holes or openings, e.g., 1807a, around the ring, an inner structure 1808 that provides an inner surface 1808a for a portion of the fluid path 1806, and an outer structure 1809 that provides an outer surface 1809a for a portion of the flow path 1806. Components 1808, 1809 or both are adjustable, e.g., their relative positions can be easily and in a predetermined manner changed, their shape can be easily and in a predetermined manner changed or both, such as by set screws, clips or changing out or substituting different size or shape pieces for components 1808 and 1809. In this manner the size, relative positions, the shape, including shape of the surface areas, and combinations of these can be varied, and thus change the characteristics of the flow path. The nozzle has a sensor 1810.

In an embodiment the components 1808 and 1809 can be a pair of thin concentrically spaced annular rings. The distance between the surfaces of these rings, thus defining the flow channel between them, can be about 0.01″, 0.01″, from about 0.008″ to about 0.1″ and larger and smaller sizes. This embodiment may also have channels near window for providing an internal gas path, to for example, prevent formation of a vortex and deposits on the window. The channels can be from about 25% to about 75%, about 50% to about 60%, about 25% to about 60%, and about 40% of the area of the annular ring, as well as larger and smaller percentages.

The nozzles disclosed herein can cut, for example, single string 9⅝″ casing under, for example the following conditions, laser power 4-14 kW, pressure 2,000-6,000 psi, flow 300-1,000 scfm, optics PDP—8.0″ focus, spot size 0.114″

In an embodiment the amount of gas turbulence from or jet, or other fluids, at the focal point of the beam is managed, minimized, reduced and eliminated. The reduced turbulence at this point, provides the ability to maintain a stable beam on the target and place and keep the beam at the intended locations on the target.

In an embodiment of a laser system, that can perform both cutting of tubulars and boring (e.g., cutting a hole for pinning, or placing a lifting pin, shackle, cable, or similar lifting or attachment device in a tubular), the system generally has device for clamping the system to the tubular. In this manner the laser system is supported by and attached to the tubular that it is cutting. The laser system has a laser cutting tool that has a laser cutting head, which can have a standard laser nozzle, or one of the types of the embodiments of FIGS. 1 to 5, and 18 to 20. The laser beam that is delivered by the laser cutting head can be from about 1 kW to about 40 kW, about 5 kW and more, about 10 kW and more, about 20 kW and more, and from about 1 kW to about 20 kW, and all powers with these ranges, as well as greater and smaller powers. The clamping device can be a split ring device, it can be magnetic, it can be a chain or cable with a cam or other tightening device, or it can be any other type of device that is known for use in attachment to a tubular, pole or column.

In an embodiment, the laser system has a motor and drive system that is used to move the laser cutting tool in a circular pattern (e.g., a hole cutting assembly). In this manner the laser beam can be moved to cut a hole in the tubular for insertion of a lifting or attachment device. It being understood that in addition to a circular hole, the hole can be any other shapes, e.g., square, crescent moon, key shaped, tear drop shaped, circular with a tab, or any other shape, including shapes that are specific to a predetermined lifting device.

In an embodiment, the laser system has a motor and drive system that is used to move the laser cutting tool in an orbital pattern around the exterior of the tubular (e.g., an orbital cutting assembly). In this manner the orbital cutting assembly can cut around and through the wall of the tubular, and in this manner the tubular is sectioned.

Generally, orbital cuts and movement are cuts where the laser beam is moved, i.e., orbits, around the inner longitudinal axis of a tubular (these can be inside-out, and outside-in cuts). Hole cutting and movement, and all other cuts, which are not orbital cuts, would including cuts where the laser beam tool is moved in a pattern that is in a plane that is parallel to the longitudinal axis of the tubular, or that are rotated about an axis that intersects with (e.g., is normal to) the longitudinal axis of the tubular. Hole cutting cuts are typically outside-in cuts, but may be inside-out.

In an embodiment, the laser system has a beam dump, e.g., a device that can absorb the laser beam, and has sufficient cooling and thermal properties to not be damage by the laser beam. The beam dump is located on the laser beam path of the laser beam cutting tool. In a preferred embodiment the beam dump orbits around the tubular, staying at all times during operation on the laser beam path, and on the opposite side of the tubular from the laser cutting tool. In this manner the beam dump orbits around the tubular as it is being cut, always staying in the laser beam path, and thus being configured and positioned to capture the laser beam if it cuts through both walls of the tubular, or otherwise exits the tubular.

One or more or all of the hole cutting assembly and the orbital cutting assembly can be attached to the clamping device. The laser system can have one laser cutting head for the hole cutting assembly and one laser cutting head for the orbital cutting assembly, or a single laser cutting head can be attached to both the orbital cutting assembly and the hole cutting assembly. In this manner, the laser head can be moved by these assemblies in an orbital manner, and in a circular manner. Additional motor and drive assemblies may also be used. One, two, three, four or more laser heads may also be used. One, two, three, four or more laser beam dumps may be used. The laser beam dumps can be associated with a single or multiple laser heads, and laser beam paths. The laser beam dump can be attached to the clamping device. The laser beam dump can be moved by the orbital motor and drive system or by a separate motor and drive system. The laser beam dump can be on the orbital laser beam path, can be on the hole cutting laser beam path, or both.

In an embodiment the laser cutting system has an enclosure that surrounds the laser work area, and thus, meets the requirements of 21 C.F.R. § 1040.10 (Revised as of Apr. 1, 2012), the entire disclosure of which is incorporated herein by reference, to be considered Class III, more preferably Class II, and still more preferably Class I. The enclosure can be attached to and supported by the clamping device. It can have windows with glass that is rated for the wavelength of the laser beam to prevent or minimize the laser beam from escaping, it can have a vent or vapor handling system to manage any vapors or fumes that are generated by the laser cutting operation.

As used in this specification a “Class I product” is equipment that will not permit access during the operation of the laser to levels of laser energy in excess of the emission limits set forth in Table I. Thus, preferably personnel operating, and in the area of operation, of the equipment will receive no more than, and preferably less than, the following exposers in Table I during operation of the laser equipment.

TABLE I
TABLE I
CLASS I ACCESSIBLE EMISSION LIMITS FOR LASER RADIATION

| Wavelength | Emission duration | Class I-Accessible emission limits | | |
|---|---|---|---|---|
| (nanometers) | (seconds) | (value) | (unit) | (quantity)** |
| ≥180 | ≤3.0 × 10⁴ - - - | 2.4 × 10⁻⁵k₁k₂* | Joules (J)* | radiant energy |
| but ≤400 | >3.0 × 10⁴ - - - | 8.0 × 10⁻¹⁰k₁k₂* | Watts (W)* | radiant power |
| >400 | >1.0 × 10⁻⁹to 2.0 × 10⁻⁵ - - - | 2.0 × 10⁻⁷k₁k₂ | J | radiant energy |
| but ≤1400 | >2.0 × 10⁻⁵to 1.0 × 10¹ - - - | 7.0 × 10⁻⁴k₁k₂t^{3/4} | J | radiant energy |
| | >1.0 × 10¹to 1.0 × 10⁴ - - - | 3.9 × 10⁻³k₁k₂ | J | radiant energy |
| | >1.0 × 10⁴ - - - | 3.9 × 10⁻⁷k₁k₂ | W | radiant power |
| | and also (See paragraph (d)(4) of this section) | | | |
| | >1.0 × 10⁻⁹to 1.0 × 10¹ - - - | 10k₁k₂t^{1/3} | Jcm⁻²sr⁻¹ | integrated radiance |
| | >1.0 × 10¹to 1.0 × 10⁴ - - - | 20k₁k₂ | Jcm⁻²sr⁻¹ | integrated radiance |
| | >1.0 × 10⁴ - - - | 2.0 × 10⁻³k₁k₂ | Wcm⁻²sr⁻¹ | radiance |
| >1400 | >1.0 × 10⁻⁹to 1.0 × 10⁻⁷ - - - | 7.9 × 10⁻⁵k₁k₂ | J | radiant energy |
| but ≤2500 | >1.0 × 10⁻⁷to 1.0 × 10¹ - - - | 4.4 × 10⁻³k₁k₂t^{1/4} | J | radiant energy |
| | >1.0 × 10¹ - - - | 7.9 × 10⁻⁴k₁k₂ | W | radiant power |
| >2500 | >1.0 × 10⁻⁹to 1.0 × 10⁻⁷ - - - | 1.0 × 10⁻²k₁k₂ | Jcm⁻² | radiant exposure |
| but ≤1.0 × 10⁶ | >1.0 × 10⁻⁷to 1.0 × 10¹ - - - | 5.6 × 10⁻¹k₁k₂t^{1/4} | Jcm⁻² | radiant exposure |
| | >1.0 × 10¹ - - - | 1.0 × 10⁻¹k₁k₂t | Jcm⁻² | radiant exposure |

*Class I accessible emission limits for wavelengths equal to or greater than 180 nm but less than or equal to 400 nm shall not exceed the Class I accessible emission limits for the wavelengths greater than 1400 nm but less than or equal to 1.0 × 10⁶ nm with a k₁ and k₂ of 1.0 for comparable sampling intervals.
**Measurement parameters and test conditions shall be in accordance with paragraphs (d)(1), (2), (3), and (4), and (e) of this section.

As used in this specification a “Class IIa product” is equipment that will not permit access during the operation of the laser to levels of visible laser energy in excess of the emission limits set forth in Table II-A; but permit levels in excess of those provided in Table I.

TABLE II-A
TABLE II-A
CLASS IIa ACCESSIBLE
EMISSION LIMITS FOR LASER RADIATION
CLASS IIa ACCESSIBLE EMISSION LIMITS
ARE IDENTICAL TO CLASS I ACCESSIBLE EMISSION
LIMITS EXCEPT WITHIN THE FOLLOWING RANGE OF
WAVELENGTHS AND EMISSION DURATIONS:

| Wavelength | Emission duration | Class IIa-Accessible emission limits | | |
|---|---|---|---|---|
| (nanometers) | (seconds) | (value) | (unit) | (quantity)* |
| >400 but ≤710 | >1.0 × 10³ | 3.9 × 10⁻⁶ | W | radiant power |

*Measurement parameters and test conditions shall be in accordance with paragraphs (d)(1), (2), (3), and (4), and (e) of this section.

As used in this specification a “Class II product” is equipment that will not permit access during the operation of the laser to levels of laser energy in excess of the emission limits set forth in Table II; but permit levels in excess of those provided in Table II-A.

TABLE II
TABLE II
CLASS II ACCESSIBLE
EMISSION LIMITS FOR LASER RADIATION
CLASS II ACCESSIBLE EMISSION LIMITS
ARE IDENTICAL TO CLASS I ACCESSIBLE
EMISSION LIMITS EXCEPT WITHIN THE FOLLOWING
RANGE OF WAVELENGTHS AND EMISSION DURATIONS:

| Wavelength | Emission duration | Class II-Accessible emission limits | | |
|---|---|---|---|---|
| (nanometers) | (seconds) | (value) | (unit) | (quantity)* |
| >400 but ≤710 | >2.5 × 10⁻¹ | 1.0 × 10⁻³ | W | radiant power |

*Measurement parameters and test conditions shall be in accordance with paragraphs (d)(1), (2), (3), and (4), and (e) of this section.

As used in this specification a “Class IIIa product” is equipment that will not permit access during the operation of the laser to levels of laser energy in excess of the emission limits set forth in Table III-A; but permit levels in excess of those provided in Table II.

TABLE III-A
TABLE III-A
CLASS IIIa ACCESSIBLE
EMISSION LIMITS FOR LASER RADIATION
CLASS IIIa ACCESSIBLE EMISSION LIMITS
ARE IDENTICAL TO CLASS I ACCESSIBLE
EMISSION LIMITS EXCEPT WITHIN THE FOLLOWING
RANGE OF WAVELENGTHS AND EMISSION DURATIONS:

| Wavelength | Emission duration | Class IIIa-Accessible emission limits | | |
|---|---|---|---|---|
| (nanometers) | (seconds) | (value) | (unit) | (quantity)* |
| >400 but ≤710 | >3.8 × 10⁻⁴ | 5.0 × 10⁻³ | W | radiant power |

*Measurement parameters and test conditions shall be in accordance with paragraphs (d)(1), (2), (3), and (4), and (e) of this section.

As used in this specification a “Class IIIb product” is equipment that will not permit access during the operation of the laser to levels of laser energy in excess of the emission limits set forth in Table III-B; but permit levels in excess of those provided in Table III-A.

TABLE III-B
TABLE III-B
CLASS IIIb ACCESSIBLE EMISSION LIMITS FOR LASER RADIATION

| Wavelength | Emission duration | Class IIIb-Accessible emission limits | | |
|---|---|---|---|---|
| (nanometers) | (seconds) | (value) | (unit) | (quantity)* |
| ≥180 | ≤2.5 × 10⁻¹ - - - | 3.8 × 10⁻⁴k₁k₂ | J | radiant energy |
| but ≤400 | >2.5 × 10⁻¹ - - - | 1.5 × 10⁻³k₁k₂ | W | radiant power |
| >400 | >1.0 × 10⁻⁹to 2.5 × 10⁻¹ - - - | 10k₁k₂t^{1/3} to a | Jcm⁻² | radiant exposure |
| but ≤1400 | >2.5 × 10⁻¹ - - - | maximum value of 10 | Jcm⁻² | radiant exposure |
| | | 5.0 × 10⁻¹ | W | radiant power |
| >1400 | >1.0 × 10⁻⁹to 1.0 × 10¹⁻ - - - | 10 | Jcm⁻² | radiant exposure |
| but ≤1.0 × 10⁶ | >1.0 × 10¹ - - - | 5.0 × 10⁻¹ | W | radiant power |

*Measurement parameter and test conditions shall be in accordance with paragraphs (d)(1), (2), (3), and (4), and (e) of this section.

The values for the wavelength dependent correction factors “k1” and “k2” for Tables I, IIA, II, IIIA, IIIB are provided in Table IV.

TABLE IV
VALUES OF WAVELENGTH DEPENDENT CORRECTION FACTORS k₁ AND k₂

| Wavelength | | | | |
|---|---|---|---|---|
| (nanometers) | k₁ | k₂ | | |
| 180 to 302.4 | 1.0 | 1.0 | | |
| >302.4 to 315 | ${10}^{[ \frac{λ - 302.4}{5} ]}$ | 1.0 | | |
| >315 to 400 | 330.0 | 1.0 | | |
| >400 to 700 | 1.0 | 1.0 | | |
| >700 to 800 | ${10}^{[ \frac{λ - 700}{515} ]}$ | $\begin{matrix}if \text{:} t \leq \frac{10100}{λ - 699} \\ then \text{:} {k}_{2} = 1.0\end{matrix}$ | $\begin{matrix}if \text{:} \frac{10100}{λ - 699} < t \leq {10}^{4} \\ then \text{:} {k}_{2} = \frac{t ( λ - 699 )}{10100}\end{matrix}$ | $\begin{matrix}if \text{:} t > {10}^{4} \\ then \text{:} {k}_{2} = \frac{λ - 699}{1.01}\end{matrix}$ |
| >800 to 1060 >1060 to 1400 | ${10}^{[ \frac{λ - 700}{515} ]}$ 5.0 | if: t ≤ 100 then: k₂ = 1.0 | $\begin{matrix}if \text{:} 100 < t \leq {10}^{4} \\ then \text{:} {k}_{2} = \frac{t}{100}\end{matrix}$ | if: t > 10⁴ then: k₂ = 100 |

| | | |
|---|---|---|
| >1400 to 1535 | 1.0 | 1.0 |
| >1535 to 1545 | t ≤ 10⁻⁷ | 1.0 |
| | k₁ = 100.0 | |
| | t > 10⁻⁷ | |
| | k₁ = 1.0 | |
| >1545 to 1.0 × 10⁶ | 1.0 | 1.0 |

Note:
The variables in the expressions are the magnitudes of the sampling interval(t), in units of seconds, and the wavelength (λ), in units of nanometers.

The measurement parameters and test conditions for Tables I, IIA, II, IIIA, and IIIB, which are referred to by paragraph numbers of “this section,” are as follows, and are provided with their respective paragraph numbers “b” and “e” as they appear in 21 C.F.R. § 1040.10 (Revised as of Apr. 1, 2012):

(b)(1)Beam of a single wavelength. Laser or collateral radiation of a single wavelength exceeds the accessible emission limits of a class if its accessible emission level is greater than the accessible emission limit of that class within any of the ranges of emission duration specified in tables I, II-A, II, III-A, and III-B.

(b)(2)Beam of multiple wavelengths in same range. Laser or collateral radiation having two or more wavelengths within any one of the wavelength ranges specified in tables I, II-A, II, III-A, and III-B exceeds the accessible emission limits of a class if the sum of the ratios of the accessible emission level to the corresponding accessible emission limit at each such wavelength is greater than unity for that combination of emission duration and wavelength distribution which results in the maximum sum.

(b)(3)Beam with multiple wavelengths in different ranges.” Laser or collateral radiation having wavelengths within two or more of the wavelength ranges specified in tables I, II-A, II, III-A, and III-B exceeds the accessible emission limits of a class if it exceeds the applicable limits within any one of those wavelength ranges.

(b)(4)Class I dual limits. Laser or collateral radiation in the wavelength range of greater than 400 nm but less than or equal to 1.400 nm exceeds the accessible emission limits of Class I if it exceeds both: (i) The Class I accessible emission limits for radiant energy within any range of emission duration specified in table I, and (ii) The Class I accessible emission limits for integrated radiance within any range of emission duration specified in table I.

(e)(1)Tests for certification. Tests shall account for all errors and statistical uncertainties in the measurement process. Because compliance with the standard is required for the useful life of a product such tests shall also account for increases in emission and degradation in radiation safety with age.

(e)(2)Test conditions. tests for compliance with each of the applicable requirements of paragraph (e) shall be made during operation, maintenance, or service as appropriate: (i) Under those conditions and procedures which maximize the accessible emission levels, including start-up, stabilized emission, and shut-down of the laser product; and (ii) With all controls and adjustments listed in the operation, maintenance, and service instructions adjusted in combination to result in the maximum accessible emission level of radiation; and (iii) At points in space to which human access is possible in the product configuration which is necessary to determine compliance with each requirement, e.g., if operation may require removal of portions of the protective housing and defeat of safety interlocks, measurements shall be made at points accessible in that product configuration; and (iv) With the measuring instrument detector so positioned and so oriented with respect to the laser product as to result in the maximum detection of radiation by the instrument; and (v) For a laser product other than a laser system, with the laser coupled to that type of laser energy source which is specified as compatible by the laser product manufacturer and which produces the maximum emission level of accessible radiation from that product.

(e)(3)Measurement parameters. Accessible emission levels of laser and collateral radiation shall be based upon the following measurements as appropriate, or their equivalent: (i) For laser products intended to be used in a locale where the emitted laser radiation is unlikely to be viewed with optical instruments, the radiant power (W) or radiant energy (J) detectable through a circular aperture stop having a diameter of 7 millimeters and within a circular solid angle of acceptance of 1*10-3steradian with collimating optics of 5 diopters or less. For scanned laser radiation, the direction of the solid angle of acceptance shall change as needed to maximize detectable radiation, with an angular speed of up to 5 radians/second. A 50 millimeter diameter aperture stop with the same collimating optics and acceptance angle stated above shall be used for all other laser products. (ii) The irradiance (W cm-2) or radiant exposure (J cm-2equivalent to the radiant power (W) or radiant energy (J) detectable through a circular aperture stop having a diameter of 7 millimeters and, for irradiance, within a circular solid angle of acceptance of 1**10-3steradian with collimating optics of 5 diopters or less, divided by the area of the aperture stop (cm-2). (iii) The radiance (W cm-2sr-1) or integrated radiance (J cm-2sr-1) equivalent to the radiant power (W) or radiant energy (J) detectable through a circular aperture stop having a diameter of 7 millimeters and within a circular solid angle of acceptance of 1*10-5steradian with collimating optics of 5 diopters or less, divided by that solid angle (sr) and by the area of the aperture stop (cm-2).

Turning to FIGS. 8 through 12C (like numbers have like meaning) there is shown structures and components of an embodiment of a laser cutting system for cutting tubulars, columns and poles, among other things. In particular, this embodiment can be used for cutting tubulars used in hydrocarbon production in offshore, as well as, onshore settings.

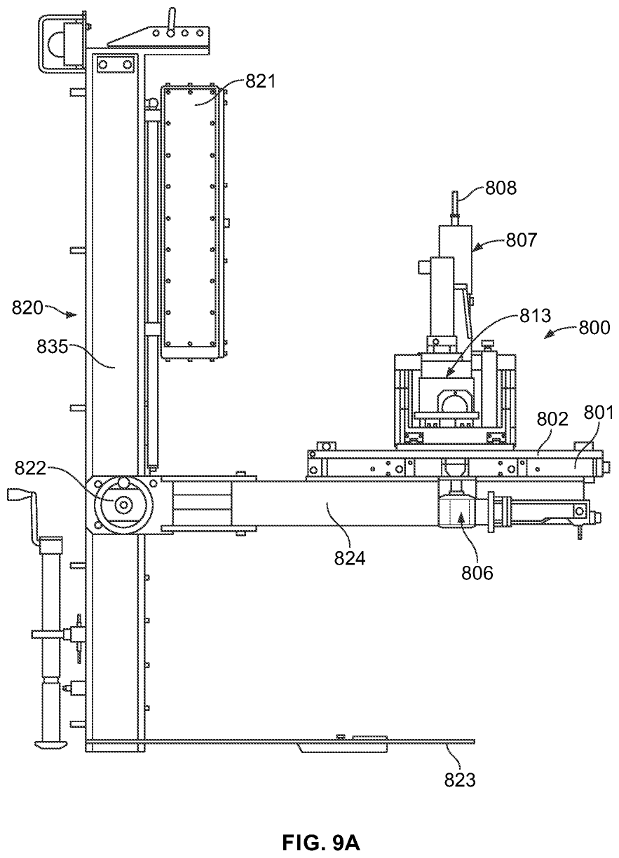

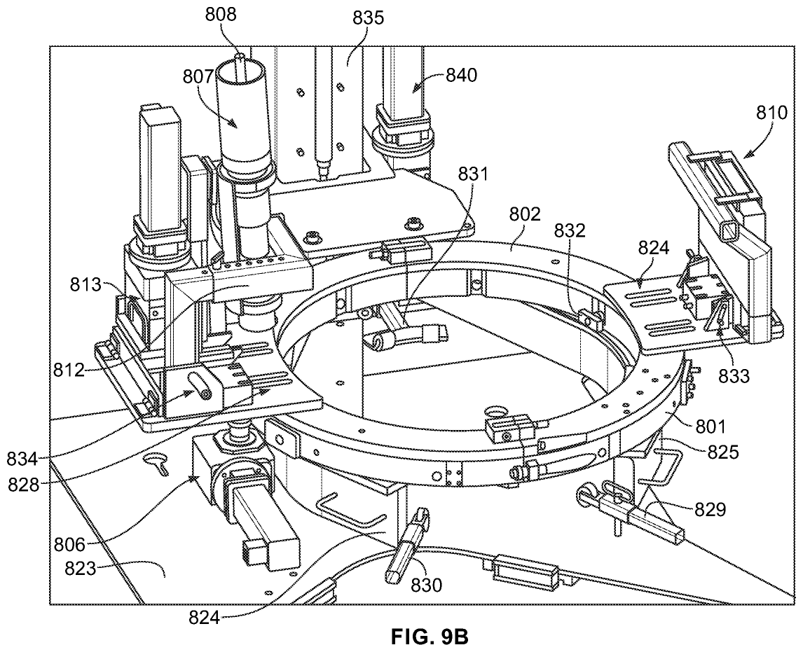

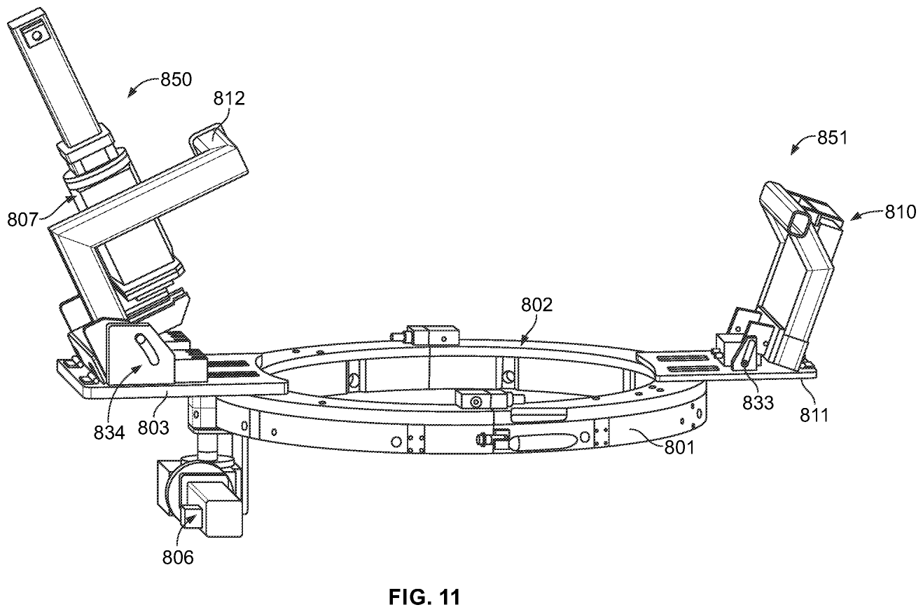

Turning to FIG. 8 the system has a cutting assembly 800. The cutting assembly 800 has an annular split ring frame 801. The split ring frame 801 is configured to be opened to go around a tubular and then closed to complete surround the tubular. The split ring frame 801 supports and has a rotating ring or disc 802 (this is also in a split configuration, for opening and then closing around the tubular). The split ring frame 801 has a connector 804 that joins the ring together, keeping it closed. The rotating split ring has a connect 805 that joins the rotating ring together, keeping in closed. Motor assembly 806 is configured to rotate ring 802. In this manner ring 802 is supported by frame 801 as ring 802 is rotated by motor assembly 806. Motor assembly 806 is fixed to and mounted on frame 801. A laser cutting apparatus 890 and a beam dump apparatus 891 are mounted on ring 802, and in this manner are rotated by ring 802. Thus, laser cutting apparatus 890 and beam dump apparatus 891 will orbit around a tubular that is located inside of ring 801. The laser cutting apparatus launches a laser beam along laser beam path 809, which extends into and ends on a graphite block 810 that is a part of the beam dump apparatus 810. The beam dump apparatus 810 has a frame 811 that holds the graphite block 810. The frame 811 is attached to the ring 802. The frame 811 further has adjustment slots 826 (which are more clearly shown in FIG. 9B) for adjusting the position of the beam dump, depending upon the size (i.e., diameter) of the tubular being cut. The laser cutting apparatus 890 has laser cutting head 807 that has a high power laser fiber 808. In operation the fiber 808 is optically connect to a source of a high power laser beam (e.g., a laser), and thus provides the high power laser bean to the laser cutting head. 807. The laser cutting apparatus 890 further has base 803 that is attached to ring 802. In this manner the laser cutting apparatus 890 is moved by ring 802. The base 803 is configured to allow the laser cutting apparatus to pivot back away from the tubular, as shown in FIG. 11, to prevent damage when a sectioned tubular is being removed, or a new section of tubular is being feed into the system. The laser cutting apparatus 890 has a protective bar 812, a motor assembly 813 that is mechanically associated with a cam lobe 814 (for moving the laser cutting head 807 in a hole cutting motion)

Turning to FIG. 9A, the cutting assembly 800, is attached to a stand assembly 820, that is configured to clamp to a tubular. The stand assembly 820 has a junction box 821, having electrical power, controllers, and other devices for the operations and monitoring of the system and cutting process. There is provided a y-axis control 822 device, which in this embodiment is a trolley mechanism that allows the arm 824 to move along (e.g., up and down) post 835. The stand assembly 820 has a lower base 823. The arm 824 are attached to split ring frame 801. The second arm 825 is shown in FIG. 9B

Turning to FIG. 9B there is provided a more detailed view of the attachment and configuration of the laser assembly 800 with the stand assembly 820. Arms 824 and 825 connect post 835 to the ring 801. Adjustment slots 826, 828 allow for the centering, adjustment and both of the laser assembly and bean dump. There are centralizers 829, 830, 831, that engage and centralize the tubular, as well as holds it relative position, while the tubular is being moved through the assembly. Break away devices 833, 834 provide the ability for the laser cutting assembly and the beam dump assembly to break away, e.g., pivot, if the tubular, or something else, pushes against them, thus reducing the chance for damage. A motor assembly 840 is provided for moving the y-axis control trolley.

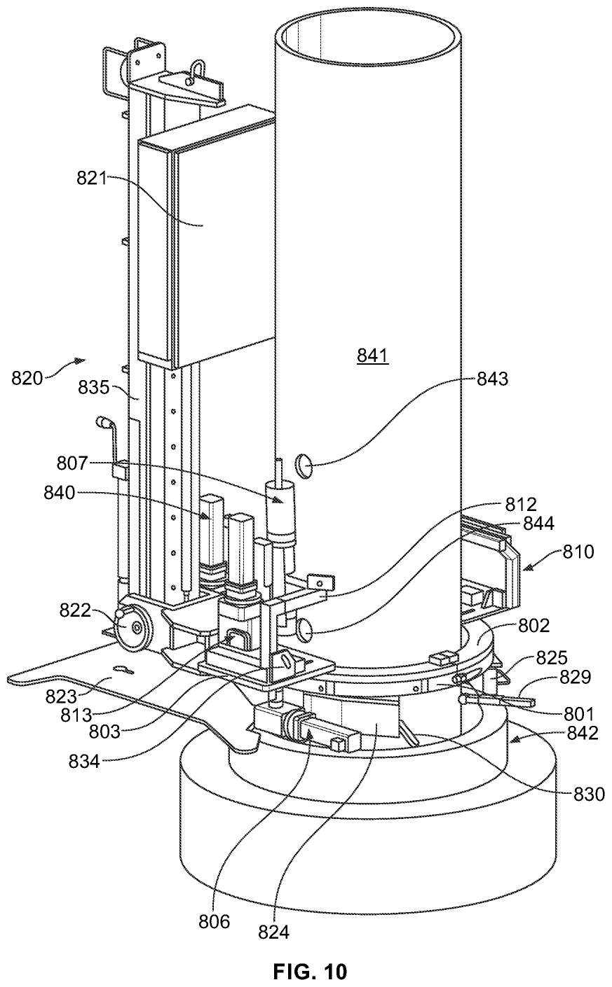

Turning to FIG. 10 there is shown a tubular 841 positioned in the apparatus. Circular holes 843, 844, have been cut into the tubular by the apparatus. There is a motor drive 840 for y-direction movement of the cutting assembly along the post 835. Arms 824, 225 and guides (829, 830 the other guide is not in view) have engaged the outer surface of the tubular. The Arms 824, 825 are holding the stand and cutting assembly on the tubular. In this manner the stand and cutting assembly are mounted on, or affixed to, the tubular that is being cut and sectioned. Rotary slips, such as those found on the drill floor of drill ship are engaged and holding the tubular in place. A spider, wedges, and other holding devices, can also be used to hold or fix the tubular to be cut in place with respect to an oil platform, drill ship, or other vessel or work platform.

FIG. 11 shows the assemblies in a break away position 850, 851. As the tubular is moved through the assembly, e.g., being pulled through by a crane or hoisting device, the assemblies can be pivoted back.

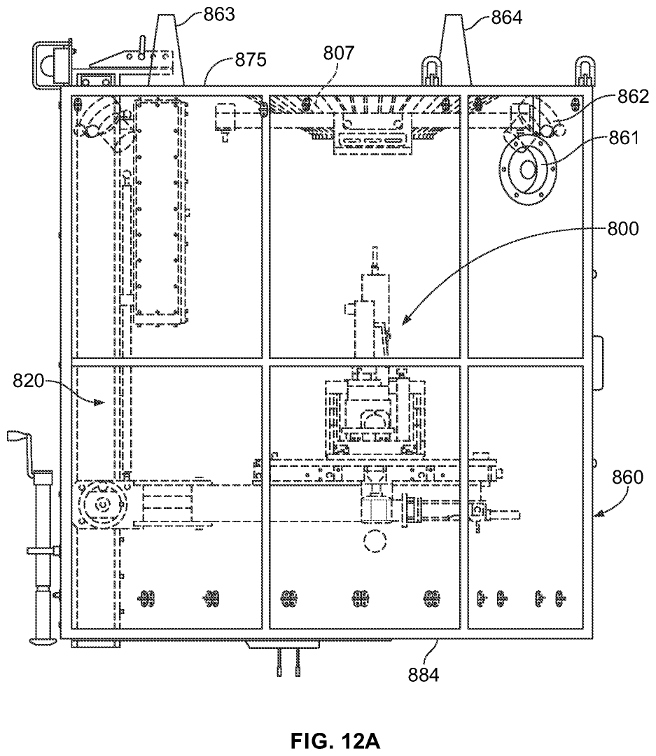

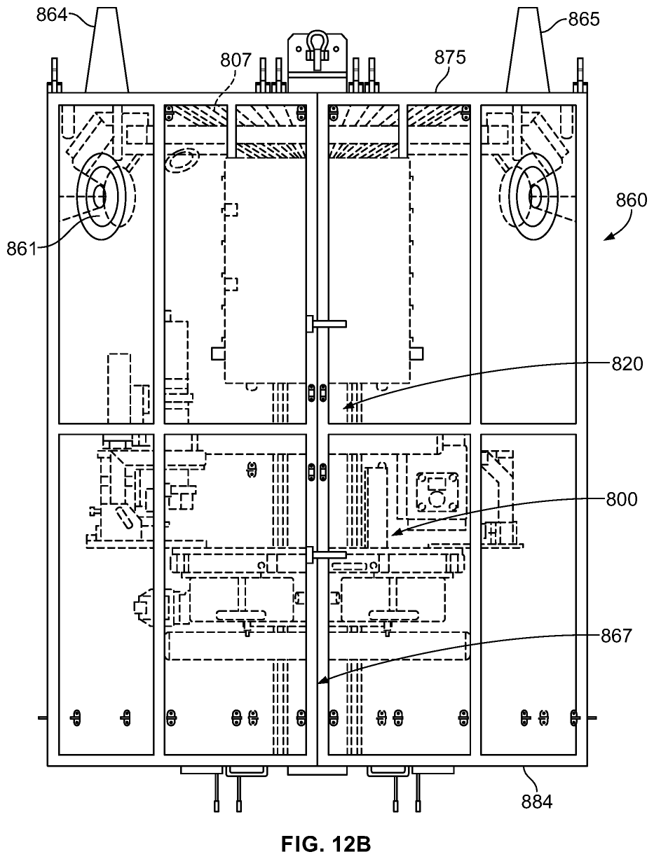

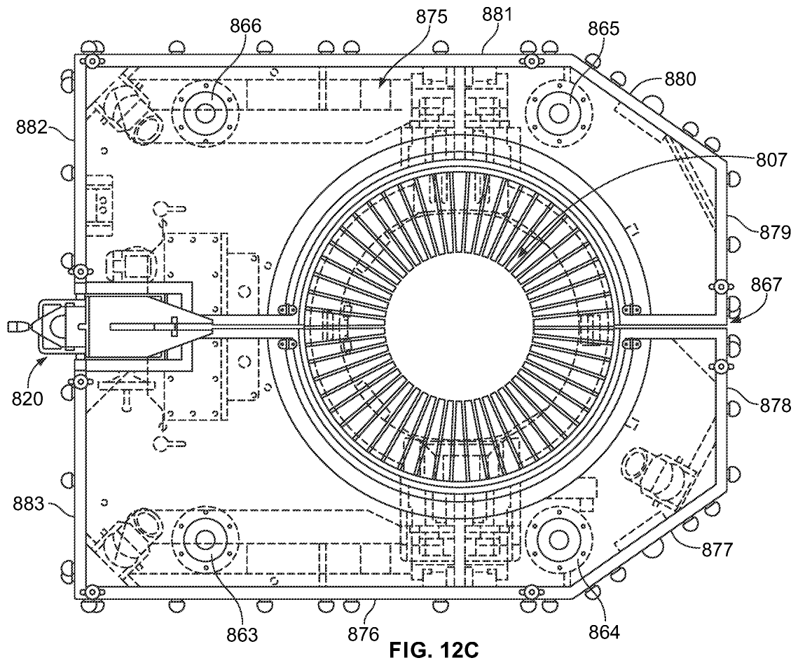

FIGS. 12A to 12C illustrate an embodiment of an enclosure that is openable and closable around the cutting assembly 800 and the stand assembly 820. FIG. 12A is a right side view of the enclosure. The enclosure is formed from a housing or cover 860. From this view it can be seen that the housing 860 has a warning light 861, a monitoring device 862 (e.g., a camera), and vent ports 863, 864, 865, 866. In FIG. 12B there is shown a front view of housing 860. The closure 867 that opens and closes to allow the housing 860 to engage around the cutting assembly 800 and stand assembly 820 is shown in a closed position. FIG. 12C is a top view of the enclosure. There is an iris 870 that engages around the tubular, and allows the tubular to be moved through the cutting assembly without opening the housing 860. The housing 860 has a top 875 forming a top surface; sides 876, 877, 878, 879, 88, 881, 882, 883 each forming respective side surfaces; and a bottom 884, forming a bottom surface.

It should be understood that while the cross sectional shape of the laser beam, or the shape of the spot on the target, is generally discussed in this specification as being circular, the beam can be other shapes, such as elliptical, rectangular, linear, square, etc. The circular beam size can have a diameter of about 0.1 mm to 15 mm, about 0.1 mm to about 1 mm, about 0.3 mm to about 0.7 mm, about 0.3 mm to about 1 mm, about 0.5 mm to about 2 mm, about 0.5 mm to about 10 mm, about 1 to about 2 mm, and all sizes within these ranges as well as larger and smaller sizes. For other shapes the laser beam spot size typically can have an area of about 0.5 mm² to 3,000 mm², about 1 mm² to 2,500 mm², about 5 mm² to 1,500 mm², about 100 mm² to 1,000 mm² and all areas within these ranges as well as larger and smaller areas.

In an embodiment the beam is rectangular having the dimensions of 2 mm×10 mm, 1.5 mm×10 mm, about 1.75 mm×about 12 mm, about 1.1 mm×about 8, about 2 mm×about 10 mm, from about 1 mm to 3 mm×from about 5 mm to 15 mm, and all rectangular dimensions within these ranges. The rectangular beam can be placed in any orientation with respect to the longitudinal axis of the tubular being cut. Thus, the long dimension of the beam, e.g., 10 mm, can be parallel to the longitudinal axis of the tubular (e.g., also perpendicular to a plane of a circular cut); or the short axis could be parallel to the longitudinal axis of the tubular (e.g., the long axis is parallel to the plane of the circular cut). The beam can also be positioned in other orientation with respect to the longitudinal axis of the tubular, the plane of the cut and either.

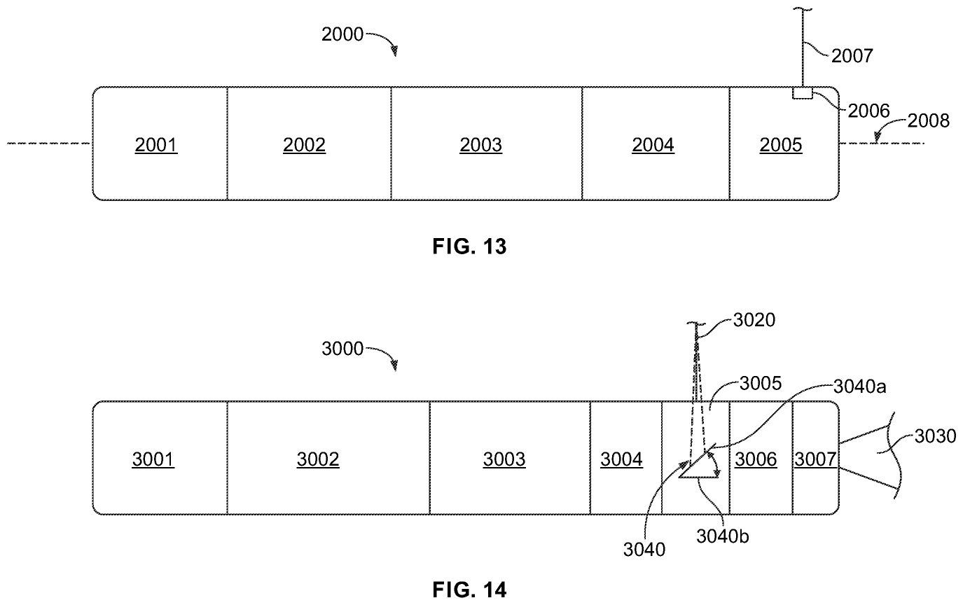

Turning to FIG. 13 there is provided a schematic of an embodiment of a laser cutting tool 2000 having a longitudinal axis shown by dashed line 2008. Embodiments of this laser cutting tool that may be used to perform laser operations, such as removal, abandonment, decommission, repair and refurbishment operations, include on single strings and on multi-strings, e.g., a tubular within one or more other tubulars. The laser cutting tool 2000 has a conveyance termination section 2001. The conveyance termination section 2000 would receive and hold, for example, a composite high power laser umbilical, a coil tube having for example a high power laser fiber and a channel for transmitting a fluid for the laser cutting head, a wireline having a high power fiber, or a slick line and high power fiber. The laser tool 2000 has an anchor and positioning section 2002. The anchor and positioning section may have a centralizer, a packer, or shoe and piston or other mechanical, electrical, magnetic or hydraulic device that can hold the tool in a fixed and predetermined position longitudinally, axially or both. The section may also be used to adjust and set the stand off distance that the laser head is from the surface to be cut. The laser tool 2000 has a motor section, which may be an electric motor, a step motor, a motor driven by a fluid, or other device to rotate the laser cutter head, or cause the laser beam path to rotate. In this configuration the laser fiber, and fluid path, if a fluid is used in the laser head, must pass by or through the motor section 2003. Motor, optic assemblies, and beam and fluid paths of the types that are disclosed and taught in the following US Patent Applications: Ser. No. 13/403,509; Ser. No. 61/403,287; Publication No. 2012/0074110; Ser. No. 61/605,429; Ser. No. 61/605,434; and, Ser. No. 13/403,132, may be utilized, the entire disclosures of each of which are incorporated herein by reference. There is provided an optics section 2004, which for example, may shape and direct the beam and have optical components such as a collimating element or lens and a focusing element or lens. Optics assemblies, packages and optical elements disclosed and taught in the following US Patent Applications: Ser. No. 13/403,132; and, Ser. No. 61/446,040 may be utilized, the entire disclosure of each of which is incorporated herein by reference. There is provided a laser cutting head section 2005, which directs and moves the laser beam along a laser beam path 2007. In this embodiment the laser cutting head 2005 has a laser beam exit 2006. In operation the laser beam path may be rotated through 360 degrees to perform a complete circumferential cut of a tubular. (It is noted that the laser beam path may be, for example: rotated a single revolution in one direction, e.g., clockwise; rotated in a reciprocal manner, e.g., clockwise for a number of degrees and then counter clockwise for the same, greater or lessor degrees; rotated in multiple revolutions, e.g., 1% revolutions, 2 revolutions, 3.75 revolutions, 4 revolutions, or more; and combinations and variations of these.) The laser beam path may also be moved along the axis of the tool. The laser beam path also may be scanned or otherwise moved in a pattern during propagation or delivery of the laser beam. In this manner, circular cuts, windows and perforations may be made to a tubular, support member, or for example a conductor. In the embodiment of FIG. 13, as well as other embodiments, the laser beam path 2007 forms a 90 degree angle with the axis of the tool 2008. This angle could be greater than 90 degrees or less then 90 degrees.

The laser tool of the embodiment of FIG. 13 utilizes the high velocity laser jets of the present inventions, e.g., the embodiments of FIGS. 1-5B and FIGS. 18 to 20. In particular, examples of embodiments of this laser tool utilize the high velocity jet of the type shown in FIG. 1A to 1C. In particular, examples of embodiments of this laser tool utilize the high velocity jet of the type shown in FIGS. 5 to 5B. In particular, examples of embodiments of this laser tool utilize the high velocity jet of the type shown in FIGS. 18 to 20.

Turning to FIG. 14, there is shown an embodiment of a laser cutting tool 3000. Embodiments of this laser cutting tool that may be used to perform laser operations, such as removal, abandonment, decommission, repair and refurbishment operations, include on single strings and on multi-strings, e.g., a tubular within one or more other tubulars. The laser cutting tool 3000 has a conveyance termination section 3001, an anchoring and positioning section 3002, a motor section 3003, an optics package 3004, an optics and laser cutting head section 3005, a second optics package 3006, and a second laser cutting head section 3007. The conveyance termination section would receive and hold, for example, a composite high power laser umbilical, a coil tube having for example a high power laser fiber and a channel for transmitting a fluid for the laser cutting head, a wireline having a high power fiber, or a slick line and high power fiber. The anchor and positioning section may have a centralizer, a packer, or shoe and piston or other mechanical, electrical, magnetic or hydraulic device that can hold the tool in a fixed and predetermined position both longitudinally and axially. The section may also be used to adjust and set the stand off distance that the laser head is from the surface to be cut. The motor section may be an electric motor, a step motor, a motor driven by a fluid or other device to rotate one or both of the laser cutting heads or cause one or both of the laser beam paths to rotate. Motor, optic assemblies, and beam and fluid paths of the types that are disclosed and taught in the following US Patent Applications: Ser. No. 13/403,509; Ser. No. 61/403,287; Publication No. 2012/0074110; Ser. No. 61/605,429; Ser. No. 61/605,434; and, Ser. No. 13/403,132, may be utilized, the entire disclosures of each of which are incorporated herein by reference. There is provided an optics section 2004, which for example, may shape and direct the beam and have optical components such as a collimating element or lens and a focusing element or lens. Optics assemblies, packages and optical elements disclosed and taught in the following US Patent Applications: Ser. No. 13/403,132; and, Ser. No. 61/446,040 may be utilized, the entire disclosure of each of which is incorporated herein by reference. The optics and laser cutting head section 3005 has a mirror 3040. The mirror 3040 is movable between a first position 3040a, in the laser beam path, and a second position 3040b, outside of the laser beam path. The mirror 3040 may be a focusing element. Thus, when the mirror is in the first position 3040a, it directs and focuses the laser beam along beam path 3020. When the mirror is in the second position 3040b, the laser beam passes by the mirror and enters into the second optics section 3006, where it may be shaped into a larger circular spot (having a diameter greater than the tools diameter), a substantially linear spot, or an elongated epical pattern, as well as other spot or pattern shapes and configurations, for delivery along beam path 3030. The tool of the FIG. 14 embodiment may be used, for example, in the boring, radially cutting and, sectioning method discussed herein, wherein beam path 3030 would be used for axial boring of a structure and beam path 3020 would be used for the axial cutting and segmenting of the structure. Like the embodiment of FIG. 13, the laser beam path 3020 may be rotated and moved axially. The laser beam path 3030 may also be rotated and preferably should be rotated if the beam pattern is other than circular and the tool is being used for boring. The embodiment of FIG. 14 may also be used to clear, pierce, cut, or remove junk or other obstructions from the bore hole to, for example, facilitate the pumping and placement of cement plugs during the plugging of a bore hole.

The laser tool of the embodiment of FIG. 14 utilizes the high velocity laser jets of the present inventions, e.g., the embodiments of FIGS. 1 to 5B, and 18 to 20. In particular, examples of embodiments of this laser tool utilize the high velocity jet of the type shown in FIG. 1A to 1C. In particular, examples of embodiments of this laser tool utilize the high velocity jet of the type shown in FIGS. 5 to 5B. In particular, examples of embodiments of this laser tool utilize the high velocity jet of the type shown in FIGS. 18 to 20.

Configurations of optical elements for collimating and focusing the laser beam can be employed with laser cutting heads to provide the desired beam properties for a particular application or tool configuration. A further consideration, however, is the management of the optical effects of fluids or debris that may be located within the beam path between laser tool and the work surface, e.g., the surface of the material to be cut.

Thus, in embodiments, the high velocity jets of the present inventions minimize the detrimental effects of such fluids and materials and substantially ensure, or ensure, that such fluids do not interfere with the transmission of the laser beam, or that sufficient laser power is used to overcome any losses that may occur from transmitting the laser beam through such fluids. Further these high velocity jets provide added benefits through the ability to clear the cut of debris, e.g., dross.

Methods, configurations and devices for the management and mitigation of back reflections are taught and disclosed in US Patent Applications Publication No. 2012/0074110 and Ser. No. 61/605,434, the entire disclosure of each of which is incorporated herein by reference.

The angle at which the laser beam contacts a surface of a work piece may be determined by the optics within the laser tool or it may be determined the positioning of the laser cutter or tool, and combinations and variations of these. The laser tools have a discharge end from which the laser beam is propagated. The laser tools also have a beam path. The beam path is defined by the path that the laser beam is intended to take, and can extend from the laser source through a fiber, optics and to the work surface, and would include as the laser path that portion that extends from the discharge end of the laser tool to the material or area to be illuminated by the laser.

Examples of laser power, fluence and cutting rates, based upon published data, are set forth in Table II. Greater, enhanced, and significantly greater and significantly enhanced cutting rates are obtainable with the high velocity jets of the present inventions.

TABLE II

| | | laser | spot | Laser | | cutting |
|---|---|---|---|---|---|---|
| | thickness | power | size | fluence | | rate |
| type | (mm) | (watts) | (microns) | (MW/cc²) | gas | (m/min) |
| mild steel | 15 | 5,000 | 300 | 7.1 | O₂ | 1.8 |
| stainless | 15 | 5,000 | 300 | 7.1 | N₂ | 1.6 |
| steel | | | | | | |

By way of example, the types of laser beams and sources for providing a high power laser beam may, by way of example, be the devices, systems, and beam shaping and delivery optics that are disclosed and taught in the following US Patent Applications and US Patent Application Publications: Publication No. US 2010/0044106, Publication No. US 2010/0044105, Publication No. US 2010/0044103, Publication No. US 2010/0044102, Publication No. US 2010/0215326, Publication No. 2012/0020631, Ser. No. 13/210,581; Ser. No. 13/403,132; Ser. No. 13/403,509; Ser. No. 13/486,795; and Ser. No. 61/493,174, the entire disclosures of each of which are incorporated herein by reference.

By way of example, umbilicals, high powered optical cables, and deployment and retrieval systems for umbilical and cables, such as spools, optical slip rings, creels, and reels, as well as, related systems for deployment, use and retrieval, are disclosed and taught in the following US Patent Applications and Patent Application Publications: Publication No. 2010/0044104; Publication No. 2010/0044106; Publication No. 2010/0044103; Publication No. 2010/0215326; Publication No. 2012/0020631; Publication No. 2012/0074110; Ser. No. 61/605,401; Ser. No. 13/403,692; Ser. No. 13/403,723; and, Ser. No. 13/437,445, the entire disclosure of each of which is incorporated herein by reference, and which may preferably be used as in conjunction with, or as a part of, the present tools, devices, systems and methods and for laser removal of an offshore or other structure. Thus, the laser cable may be: a single high power optical fiber; it may be a single high power optical fiber that has shielding; it may be a single high power optical fiber that has multiple layers of shielding; it may have two, three or more high power optical fibers that are surrounded by a single protective layer, and each fiber may additionally have its own protective layer; it may contain other conduits such as a conduit to carry materials to assist a laser cutter, for example oxygen; it may have conduits for the return of cut or waste materials; it may have other optical or metal fiber for the transmission of data and control information and signals; it may be any of the combinations set forth in the forgoing patents and combinations thereof.

In general, the optical cable, e.g., structure for transmitting high power laser energy from the system to a location where high power laser activity is to be performed by a high power laser tool, may, and preferably in some applications does, also serve as a conveyance device for the high power laser tool. The optical cable, e.g., conveyance device can range from a single optical fiber to a complex arrangement of fibers, support cables, armoring, shielding on other structures, depending upon such factors as the environmental conditions of use, tool requirements, tool function(s), power requirements, information and data gathering and transmitting requirements, etc.

Generally, the optical cable may be any type of line structure that has a high power optical fiber associated with it. As used herein the term line structure should be given its broadest construction, unless specifically stated otherwise, and would include without limitation, wireline, coiled tubing, logging cable, umbilical, cable structures used for completion, workover, drilling, seismic, sensing logging and subsea completion and other subsea activities, scale removal, wax removal, pipe cleaning, casing cleaning, cleaning of other tubulars, cables used for ROV control power and data transmission, lines structures made from steel, wire and composite materials such as carbon fiber, wire and mesh, line structures used for monitoring and evaluating pipeline and boreholes, and would include without limitation such structures as Power & Data Composite Coiled Tubing (PDT-COIL) and structures such as Smart Pipe®. The optical fiber configurations can be used in conjunction with, in association with, or as part of a line structure.

Generally, these optical cables may be very light. For example an optical fiber with a Teflon shield may weigh about ⅔ lb per 1000 ft, an optical fiber in a metal tube may weight about 2 lbs per 1000 ft, and other similar, yet more robust configurations may way as little as about 5 lbs or less, about 10 lbs or less, and about 100 lbs or less per 1,000 ft. Should weight not be a factor, and for very harsh, demanding and difficult uses or applications, the optical cables could weigh more, e.g., 10% to 50% more and could weigh substantially more, e.g., 50% to 200% and more.

By way of example, the conveyance device or umbilical for the laser tools transmits or conveys the laser energy and other materials that are needed to perform the operations. It may also be used to handle any waste or returns, by for example having a passage, conduit, or tube incorporated therein or associated therewith, for carrying or transporting the waste or returns to a predetermined location, such as for example to the surface, to a location within the structure, tubular or borehole, to a holding tank on the surface, to a system for further processing, and combinations and variations of these. Although shown as a single cable multiple cables could be used. Thus, for example, in the case of a laser tool employing a high velocity laser jet the conveyance device could include a high power optical fiber and a first line for the jet fluid, in addition control data and monitoring data lines may also be present. These lines could be combined into a single cable or they may be kept separate. The lines and optical fibers in embodiments can be covered in flexible protective coverings or outer sheaths to protect them from fluids, the work environment, and the movement of the laser tool to a specific work location, for example through a pipeline or down an oil, gas or geothermal well, while at the same time remaining flexible enough to accommodate turns, bends, or other structures and configurations that may be encountered during such travel.

By way of example, one or more high power optical fibers, as well as, lower power optical fibers may be used or contained in a single cable that connects the tool to the laser system, this connecting cable could also be referred to herein as a tether, an umbilical, wire line, or a line structure. The optical fibers may be very thin on the order of hundreds e.g., about greater than 100, of μm (microns). These high power optical fibers have the capability to transmit high power laser energy having many kW of power (e.g., 5 kW, 10 kW, 20 kW, 50 kW or more) over hundreds and many thousands of feet. The high power optical fiber further provides the ability, in a single fiber, although multiple fibers may also be employed, to convey high power laser energy to the tool, convey control signals to the tool, and convey back from the tool control information and data (including video data) and cut verification, e.g., that the cut is complete. In this manner the high power optical fiber has the ability to perform, in a single very thin, less than for example 1000 μm diameter fiber, (in an embodiment about 300 μm to about 700 μm, and preferably about 400 μm), the functions of transmitting high power laser energy for activities to the tool, transmitting and receiving control information with the tool and transmitting from the tool data and other information (data could also be transmitted down the optical cable to the tool). As used herein the term “control information” is to be given its broadest meaning possible and would include all types of communication to and from the laser tool, system or equipment.

In the laser cutting process, a high power laser beam is directed at and through the material to be cut with a high pressure fluid, e.g., gas, jet for, among other things, clearing debris from the laser beam path. In embodiments, for example, the laser beam can be propagated by a long focal length optical system, with the focus either midway through the material or structure to be cut, or at the exit of the outer surface of that material or structure. When the focus is located midway through the material or structure, there is a waist (of the laser beam) in the hole that the laser forms in that material or structure, which replicates the focal point of the laser. This beam waist may make it difficult to observe the cut beyond this point because the waist can be quite small. The waist may also be located in addition to midway through, at other positions or points along the cut line, or cut through the material.

By way of example, the laser systems of the present invention may utilize a single high power laser, or they may have two or three high power lasers, or more. High power solid-state lasers, specifically semiconductor lasers, diode lasers, and fiber lasers are preferred, because of their short start up time and essentially instant-on capabilities. The high power lasers for example may be fiber lasers or semiconductor lasers having about 5 kW and greater, about 10 kW greater, about 20 kW and greater, about 50 kW, and about 1 kW to about 50 kW, and all powers within these ranges, as well as, higher powers and, which emit laser beams with wavelengths in the range from about 455 nm (nanometers) to about 2100 nm, in the range about 400 nm to about 600 nm, about 450 nm to about 650 nm, about 800 nm to about 1600 nm, about 1060 nm to 1080 nm, 1530 nm to 1600 nm, 1800 nm to 2100 nm, and more preferably about 1064 nm, about 1070-1083 nm, about 1360 nm, about 1455 nm, 1490 nm, or about 1550 nm, or about 1900 nm (wavelengths in the range of 1900 nm may be provided by Thulium lasers) and all wavelengths within these ranges, as well as high and lower wavelengths. Thus, by way of example, the present tools, systems and procedures may be utilized in a system that is contemplated to use four, five, or six, 20 kW lasers to provide a laser beam in a laser tool assembly having a power greater than about 60 kW, greater than about 70 kW, greater than about 80 kW, greater than about 90 kW and greater than about 100 kW. One laser may also be envisioned to provide these higher laser powers. Examples of preferred lasers, and in particular solid-state lasers, such as fibers lasers, are disclosed and taught in the following US Patent Applications and US Patent Application Publications: Publication No. US 2010/0044106, Publication No. US 2010/0044105, Publication No. US 2010/0044103, Publication No. US 2010/0044102, Publication No. US 2010/0215326, Publication No. 2012/0020631, Ser. No. 13/210,581, and Ser. No. 61/493,174, the entire disclosures of each of which are incorporated herein by reference. Additionally, a self-contained battery operated laser system may be used.

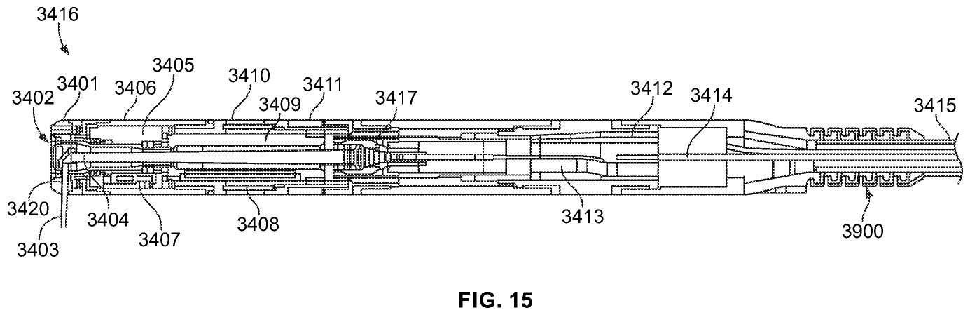

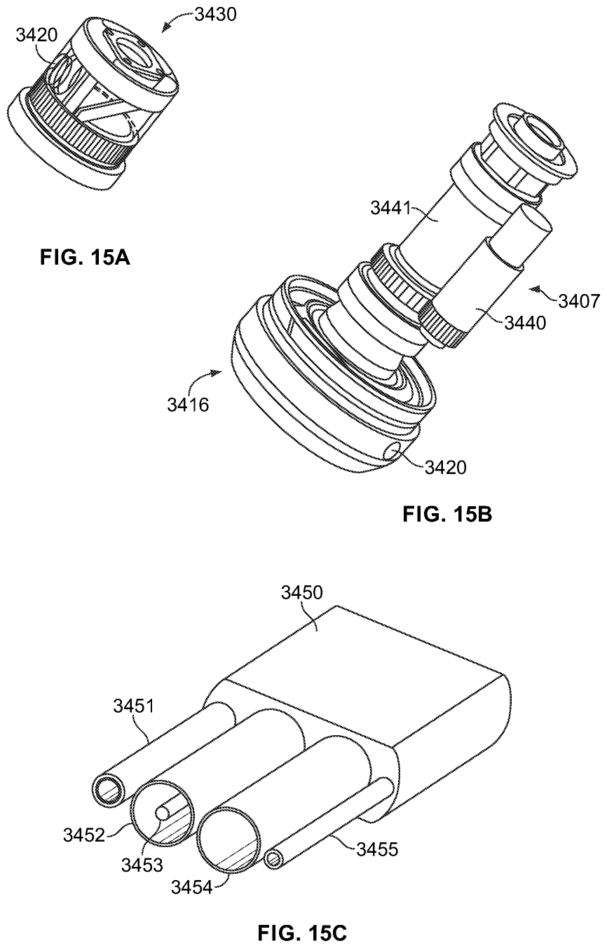

Thus, turning to FIGS. 15 and 15A to 15C there is provided an embodiment of a laser tool 3400. Embodiments of this laser cutting tool that may be used to perform laser operations, such as removal, abandonment, decommission, repair and refurbishment operations, include on single strings and on multi-strings, e.g., a tubular within one or more other tubulars. The laser tool 3400 has a lower or bottom section 3416 that rotates. The bottom section 3416 has a returns intake 3402, a high velocity jet nozzle 3420, that discharges a high velocity fluid laser jet 3403, which is rotated around by the bottom section 3416. The tool 3400 has a drive chassis 3405 within an outer chassis housing 3406. The drive chassis 3404 has a laser beam tube 3441 for transmitting the laser beam 3404. The drive chassis 3404 has a motor section 3407 for rotating the bottom section 3416. Connected to the drive chassis 3404 is an electronics chassis 3409, which has an electronics package 3408 (e.g., motor control, sensor). There is also provided a pressure sensor 3401. There is a packer 3411 and an anchor 3410. The tool 3400 has an optics package 3417, a channel 3413 for providing a fluid supply for the high velocity fluid laser jet, a channel 3412 for providing hydraulic fluid to the packer and anchor, a wireline 3414 for supporting the weight of the tool, and an umbilical 3415. Turning to FIG. 15B there is provided a perspective view of the bottom section 3416, and the motor section 3407 showing the motor 3440 and the beam tube 3441. Within the bottom section 3416 is a prism assembly 3430.

FIG. 15C is a schematic view of an embodiment of an integrated umbilical, having an outer member 3450, incorporating a hydraulics line 3451, a line 3452 for conveying the fluid for the high velocity fluid laser jet as well as acting as a possible strength member, the line 3452 containing a high power optical fiber in a metal tube 3453, a line 3454 for bringing returns (e.g., waste, cut material) away from the cut area, e.g., to the surface, and a line 3455 for providing electric power. In other embodiments the waste return line is not needed, is not a part of the umbilical, or both.

The laser tool of the embodiment of FIGS. 15, 15A to B utilizes the high velocity laser jets of the present inventions, e.g., the embodiments of FIGS. 1 to 5B and FIGS. 18 to 20. In particular, examples of embodiments of this laser tool utilize the high velocity jet of the type shown in FIGS. 1A to 1C. In particular, examples of embodiments of this laser tool utilize the high velocity jet of the type shown in FIGS. 5 to 5B. In particular, examples of embodiments of this laser tool utilize the high velocity jet of the type shown in FIGS. 18 to 20.

In FIG. 16 there is provided an embodiment of a laser cutting tool that may be used to perform laser operations, such as removal, abandonment, decommissioning, repair and refurbishment operations, include for single strings and for multi-strings, e.g., a tubular within one or more other tubulars. Thus, there is provided a laser tool having a body 2411, which is positioned inside of an inner surface 2401 of a tubular, e.g., a pile, a pile and conductor, a multi-string conductor, and combinations and variations of these, to be cut. The laser tool body 2411 has an optic package 2405, that focuses and directs the laser beam along beam path 2406 to a reflective device, 2407, for example a TIR reflective prism. The laser beam traveling along the beam path leaves the reflective device 2407 and travels toward the target, e.g., the intended area of laser illumination.

To obtain deep cuts, the beam has a long depth of field, and thus has a first spot size at 2408, which is in the area of the inner surface of the tubular 2401, a focus point 2410 which is removed from the inner surface of tubular 2401 and a second spot size 2409, which is removed from the focal point 2410. In this manner the tool, thus configured, would have an effective cut distance between spots 2408 and 2409, for a predetermined laser fluence, which is established to meet the material and cutting speed requirements for the operation.

The embodiment of FIG. 16, would be a completely on-axis embodiment, i.e., three axis are aligned. Thus, there is an axis for the tubular to be cut 2402c, an axis for the tool body 2402b, and an axis for the optics package (including the beam path exiting the optics package) 2402a. In this embodiment all axis are substantially co-axial, and preferable co-axial, i.e., on a same axis as shown in FIG. 16.

The tool has fixation devices 2404, 2403, which may serve to anchor, centralize, fix the tool at a predetermined stand-off distance, and which may also be, or serve as, a packer. Any fixation device known to the art may be used. Preferably, the fixation device will have the ability to be used across a wide range of tubular inner diameters.

The laser tool of the embodiment of FIG. 16 utilizes the high velocity laser jets of the present inventions, e.g., the embodiments of FIGS. 1 to 5B. In particular, examples of embodiments of this laser tool utilize the high velocity jet of the type shown in FIGS. 1A to 1C. In particular, examples of embodiments of this laser tool utilize the high velocity jet of the type shown in FIGS. 5 to 5B. In particular, examples of embodiments of this laser tool utilize the high velocity jet of the type shown in FIGS. 18 to 20.

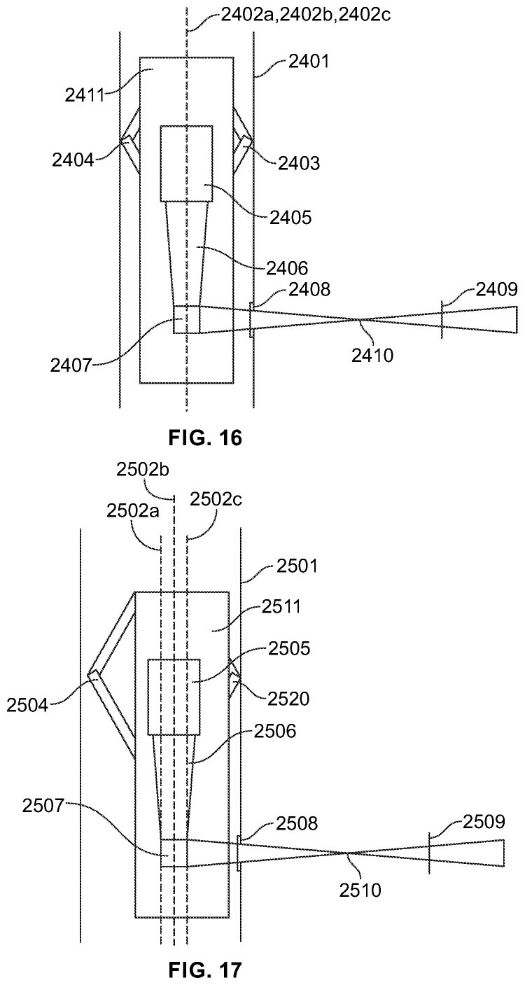

Turning to FIG. 17 there is provided an embodiment of a laser cutting tool that may be used to perform laser operations, such as removal, abandonment, decommission, repair and refurbishment operations, include for single strings and for multi-strings, e.g., a tubular within one or more other tubulars. Thus, there is provided a laser tool having a body 2511, which is positioned inside of an inner surface 2501 of a tubular, e.g., a pile, a pile and conductor, a multi-string conductor, and combinations and variations of these, to be cut. The laser tool body 2511 has an optic package 2505, that focuses and directs the laser beam along beam path 2506 to a reflective device 2507, for example a reflective prism. The laser beam traveling along the beam path leaves the reflective device 2507 and travels toward the target, e.g., the intended area of laser illumination.

To obtain deep cuts, the beam has a long depth of field, and thus, has a first spot size at 2508, which is in the area of the inner surface of the tubular 2501, a focus point 2510 which is removed from the inner surface of tubular 2501 and a second spot size 2509, which is removed from the focal point 2510. In this manner the tool, thus configured, would have an effective cut distance between spots 2508 and 2509, for a predetermined laser fluence, which is established to meet the material and cutting speed requirements for the operation.

This embodiment of FIG. 17, would be a three off-axis embodiment, i.e., three axis are not aligned. Thus, there is an axis for the tubular to be cut 2502c, an axis for the tool body 2502b, and an axis for the optics package (including the beam path exiting the optics package) 2502a. In this embodiments these three axis are not co-axial, with each axis, as shown in the Figure, having a separate position.

The tool has fixation devices 2504, which may serve to anchor, and fix the tool at a predetermined stand-off distance, and which may also serve as a packer. There is also provided a roller, bumper, or stand-off device 2520, which engages the inner surface 2520. Any fixation device and stand-off device known to the art may be used. Preferably, the fixation device will have the ability to be used across a wide range of tubular inner diameters.

Embodiments of these laser cutting tools, for inside out cut embodiments, may have one, two or three of these axis coaxial.

The laser tool of the embodiment of FIG. 16 utilizes the high velocity laser jets of the present inventions, e.g., the embodiments of FIGS. 1 to 5B. In particular, examples of embodiments of this laser tool utilize the high velocity jet of the type shown in FIGS. 1A to 1C. In particular, examples of embodiments of this laser tool utilize the high velocity jet of the type shown in FIGS. 5 to 5B. In particular, examples of embodiments of this laser tool utilize the high velocity jet of the type shown in FIGS. 18 to 20.

In addition to these, examples, the high power laser removal systems, tools, devices and methods of the present inventions may find other uses and applications in activities such as subsea beveling; decommissioning other types of offshore installations and structures; emergency pipeline repairs; cutting and removal of structures in refineries; civil engineering projects and construction and demolitions; removal of piles and jetties; removal of moorings and dolphins; concrete repair and removal; cutting of effluent and discharge pipes; maintenance, cleaning and repair of intake pipes; making small diameter bores; cutting below the mud line; precise, in-place milling and machining; heat treating; cutting elliptical man ways; and cutting deck plate cutting.

The examples are provided herein are to illustrate various embodiments of the present systems and methods of the present inventions. These examples are for illustrative purposes, may be prophetic, and should not be viewed as limiting, and do not otherwise limit the scope of the present inventions.

The various embodiments of systems, tools, laser heads, cutting heads, high velocity nozzles, high velocity fluid jets and devices set forth in this specification may be used with various high power laser systems and conveyance structures, in addition to those embodiments of the Figures in this specification. The various embodiments of systems, tools, laser heads, cutting heads, high velocity nozzles, high velocity fluid jets and devices set forth in this specification may be used with other high power laser systems that may be developed in the future, or with existing non-high power laser systems, which may be modified, in-part, based on the teachings of this specification, to create a laser system. Further the various embodiments of systems, tools, laser heads, cutting heads, high velocity nozzles, high velocity fluid jets and devices set forth in the present specification may be used with each other in different and various combinations. For example, the components of an embodiment having A, A′ and B and the components of an embodiment having A″, C and D can be used with each other in various combinations, e.g., A, C, D, and A. A″ C and D, etc., in accordance with the teaching of this Specification. Thus, for example, the laser heads, high velocity nozzles and tool configurations provided in the various embodiments of this specification may be used with each other; and the scope of protection afforded the present inventions should not be limited to a particular embodiment, configuration or arrangement that is set forth in a particular embodiment, or in an embodiment in a particular Figure.

The invention may be embodied in other forms than those specifically disclosed herein without departing from its spirit or essential characteristics. The described embodiments are to be considered in all respects only as illustrative and not restrictive.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A method of removing a section of a member from an offshore structure comprising:
a. operably associating a high power laser system with the offshore structure, the high power laser system comprising a high power laser and a high power laser cutting tool; the high power laser cutting tool comprising a high velocity laser jet nozzle, wherein the nozzle is selected from the group consisting of conanda laser jet nozzles and flow through window laser jet nozzles;
b. the high power laser cutting tool defining a laser beam delivery path for delivery of a high power laser beam along the beam path;
c. positioning the laser cutting tool adjacent a member of the offshore structure, whereby the laser beam path extends from the cutting tool to the member;
d. propagating a high power laser beam along the beam path and moving the beam path and laser beam thereby cutting the member, whereby a section of the member is formed in a predetermined manner; and,
e. removing the section from the structure.

16. The method of claim 15, wherein the member is located below a surface of a body of water.

17. The method of claim 15, wherein the member is a tubular and the cut is an inside-to-outside cut.

18. The method of claim 15, wherein the member is a tubular and the cut is an outside-to-inside cut.

19. The method of claim 15, wherein at least a portion of the member is located above the surface of a body of water.

20. The method of claim 15, wherein at least a portion of the member is located below a sea floor.

21. The method of claim 15, wherein at least a portion of the member is in the sea floor.

22. The method of claim 15, wherein the laser beam path is positioned in the body of water.

23. The method of claim 15, wherein the laser beam path is positioned below a sea floor.

24. The method of claim 15, further comprising the laser beam cutting a control line.

25. The method of claim 15, further comprising the laser beam cutting a control line; and, wherein the laser beam propagated along the beam path is at least about 10 kW.

26. The method of claim 18, wherein the laser beam propagated along the beam path is at least about 15 kW.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A method of cutting material associated with an offshore structure comprising:
a. positioning a high power laser system proximate to the offshore structure in a body of water, the high power laser system comprising a high power laser optically associated by means of an umbilical with a high power laser cutter assembly; the high power laser cutting assembly comprising a high velocity laser jet nozzle, wherein the nozzle is selected from the group consisting of conanda laser jet nozzles and flow through window laser jet nozzles;
b. the high power laser cutter assembly defining a laser beam delivery path for delivery of a high power laser beam along the beam path;
c. positioning the beam path below the surface of the body of water;
d. propagating a high power laser beam along the beam path below the surface of the body of water; and,
e. changing the relative position of a member to be cut and the laser beam path, whereby the laser beam strikes the member below the surface of the body of water and thereby cuts the member below the surface of the body of water.

41. The method of claim 40, further comprising the laser beam cutting a control line.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. A method of plugging and abandoning a well using a high power laser system, the method comprising:
a. selecting a borehole in the surface of the earth forming a well, the borehole having a tubular contained therein, the tubular extending below the surface of the earth;
b. placing a first plug within the borehole;
c. cutting the tubular at a location within the borehole and removing at least a some of the cut tubular from the borehole; placing a second plug within the borehole, the second plug being located closer to the surface of the earth than the first plug;
d. delivering a high power laser beam along a beam path to cut all tubulars within the borehole at a second location above the second plug, wherein the laser beam is delivered from a high velocity laser jet nozzle, wherein the nozzle is selected from the group consisting of conanda laser jet nozzles and flow through window laser jet nozzles; wherein the delivery of the laser beam completely severs all tubulars at the location within the borehole; and,
e. removing all of the severed tubulars from the borehole above the second location, wherein the borehole above the second location is free from tubulars.

61. The method of claim 60, further comprising the laser beam cutting a control line.

62. A laser cutting assembly for performing laser operations on a target, the system comprising:
a. a base; the base comprising an opening for receiving the target; and an orbital ring;
b. the orbital ring in association with a drive assembly, whereby the orbital ring is configured for orbital motion with respect to the base and around the target when the target is received within the opening;
c. a laser cutting head, the laser cutting head is mechanically attached to the orbital ring at a first location; whereby the laser cutting head defines a laser beam path;
d. a laser beam dump, the laser beam dump is connected to the orbital ring at a second location;
e. whereby the laser beam path extends from the laser cutting head to the laser beam dump; wherein the laser beam path is in contact with the laser beam dump; and,
f. wherein upon orbiting of the orbital ring, the laser beam path remains in contact with the laser beam dump.

63. The laser cutting assembly of claim 62, wherein the base is a split ring.

64. The laser cutting assembly of claim 62, wherein the orbital ring is a split ring.

65. The laser cutting assembly of claim 62, wherein the assembly further comprises an outer containment housing.

66. The laser cutting assembly of claim 62, wherein the assembly further comprises an outer containment housing, thereby defining a laser cutting system; whereby the laser cutting system is a Class I product.

67. The laser cutting assembly of claim 62, wherein the assembly further comprises an outer containment housing, thereby defining a laser cutting system; whereby the laser cutting system is a Class IIa product.

68. The laser cutting assembly of claim 62, wherein the assembly further comprises an outer containment housing, thereby defining a laser cutting system; whereby the laser cutting system is a Class II product.

69. (canceled)
